(19) United States
(12) Patent Application Publication
(10) Pub. No.: US 2009/0082957 A1
(43) Pub. Date: Mar. 26, 2009

(54) Electric Vehicle Network

(76) Inventors: Shai Agassi, Palo Alto, CA (US); Andrey J. Zarur, Winchester, MA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 12/234,591

(22) Filed: Sep. 19, 2008

Related U.S. Application Data
(60) Provisional application No. 60/973,794, filed on Sep. 20, 2007.

(51) Int. Cl. G01C 21/00; G06Q 10/00

(52) U.S. Cl. 701/208; 701/207; 705/1

(57) ABSTRACT

An electric vehicle that includes an electric motor that drives one or more wheels of the vehicle and is powered by a battery. The electric vehicle determines a status of a battery of the vehicle and a geographic location of the vehicle. The electric vehicle then identifies at least one battery service station that the vehicle can reach based on the charge status of the battery of the vehicle and the geographic location of the vehicle. The electric vehicle displays the at least one battery service station to a user of the vehicle.

### RELATED APPLICATIONS

This application claims priority to U.S. Provisional Patent Application No. 60/973,794, filed on Sep. 20, 2007, which is hereby incorporated by reference in its entirety.

### TECHNICAL FIELD

The disclosed embodiments relate generally to electric vehicles. In particular, the disclosed embodiments relate to an electric vehicle network and the relationships between a vehicle's user, a service provider, a power provider, and/or a financial institution.

### BACKGROUND

The vehicle (e.g., cars, trucks, planes, boats, etc.) is an integral part of the modern economy. Unfortunately, fossil fuels, like oil, used to power automobiles have numerous drawbacks including: a dependence on limited foreign sources for these fossil fuels, pollution, and climate change. One solution to these problems is to increase the fuel economy of automobiles. Recently, gasoline-electric hybrid vehicles have been introduced, which have fuel economies that are substantially higher than the fuel economy of their traditional non-hybrid counterparts. However, hybrid vehicles do not eliminate the need for fossil fuels.

Another solution to these problems is to use clean engine technologies such as engines powered by fuel cells or batteries. However, many of these clean engine technologies are not yet practical. For example, fuel cell vehicle are still in the development stage and are expensive. Similarly, battery technology has not advanced to the point where batteries can power electric vehicles for long distances. Batteries are costly and may add as much as 40% to the cost of a vehicle. Furthermore, batteries can take many hours to recharge.

Accordingly, it would be highly desirable to provide a vehicle that addresses the above described drawbacks.

### SUMMARY

In order to overcome the above described drawbacks, some embodiments provide an electric vehicle that includes a battery that can be quickly exchanged. In doing so, a spent (or partially spent) battery can be exchanged for a charged battery. Thus, the long battery recharge time is no longer required by a user of the electric vehicle who is traveling long distances. Furthermore, the cost of the electric vehicle can be substantially reduced because the battery of the electric vehicle is no longer an integral part of the vehicle. Thus, the battery can be owned by a party other than the user of the vehicle. For example, a financial institution or a service provider may own the battery and charge the user based on the battery services (e.g., charging the battery, exchanging the battery, etc.) that are provided. Finally, since the electric vehicle is powered by a battery, the dependence on foreign sources of fossil fuels can be eliminated. Furthermore, the energy required to charge the battery can be generated by renewable and/or clean resources (e.g., solar power, wind power, hydroelectric power, etc.).

Some embodiments provide a network of battery service stations that can exchange and/or charge batteries of a vehicle. The term “battery service station” is used herein to refer to battery exchange stations, which exchange spent (or partially spent) batteries of the vehicle for charged batteries, and/or charge stations, which provide energy to charge the battery of the vehicle. Furthermore, the term “charge spot” can refer to a “charge station.”

Some embodiments provide a method, a computer readable storage medium, and a system for providing information about battery service stations to vehicles. The vehicle includes an electric motor that drives one or more wheels of the vehicle, wherein the electric motor receives energy from the battery. In these embodiments, a system including hardware and/or software (e.g., a vehicle operating system) provides an interface between the user and a service provider and between the vehicle and the vehicle-area network. In some embodiments, the vehicle operating system is integrated with the vehicle controller-area network (CAN) and multimedia head unit. The vehicle operating system may provide energy management, navigation, charge management, support service and other media and content services and can integrate network services within the vehicle sending information between the vehicle and the network, multimedia components, and other services. The vehicle operating system can determine a status of a battery of the vehicle. The vehicle operating system then determines a geographic location of the vehicle. The vehicle operating system displays the geographic location of the vehicle relative to battery service stations on a map in the user interface of a positioning system of the vehicle. In some embodiments, the vehicle operating system then identifies the battery service stations that the vehicle can reach based on the status of the battery of the vehicle and the geographic location of the vehicle and displays these battery service stations on the map.

Some embodiments provide a method, a computer readable storage medium, and a system for providing information about battery service stations to vehicles. A service provider receives a status of a battery of the vehicle and a geographic location of the vehicle from a vehicle over a data network. Note that a service provider is also referred to as a “service control center.” The vehicle includes an electric motor that drives one or more wheels of the vehicle, wherein the electric motor receives energy from the battery. The service provider then determines from the status of the battery that the battery needs to be recharged. The service provider determines battery service stations based at least in part on the status of the battery and the geographic location of the vehicle. The service provider then transmits information about the battery service stations to the vehicle over the data network.

In some embodiments, the information about the battery service stations is displayed on a map in a user interface of a positioning system of the vehicle.

In some embodiments, determining from the status of the battery that the battery needs to be recharged includes determining whether a charge level of the battery is below a specified threshold.

In some embodiments, the battery service stations are selected from the group consisting of: charge stations that recharge the one or more batteries of the vehicle; battery exchange stations that replace a spent battery of the vehicle with a charged battery; and any combination of the aforementioned battery service stations.

In some embodiments, the battery is not owned by the user of the vehicle. In these embodiments, the user of the vehicle is selected from the group consisting of: a user that has legal title to the vehicle; and a user that has legal possession of the vehicle as part of a financing agreement for the vehicle.

In some embodiments, prior to receiving the status of the battery of the vehicle and the geographic location of the vehicle from the vehicle over the data network, the service provider requests the status of the battery of the vehicle from the vehicle over the data network and requests the geographic location of the vehicle from the vehicle over the data network.

In some embodiments, the service provider periodically transmits information about battery service stations to the vehicle over the data network.

In some embodiments, the service provider receives a selection of a battery service station from the user of the vehicle over the data network and reserves time at the battery service station for the vehicle.

In some embodiments, determining battery service stations based at least in part on the status of the battery and the geographic location of the vehicle includes: determining a maximum distance that the vehicle can travel before the battery can no longer power the electric motor of the vehicle and selecting the battery service stations within the maximum distance from the geographic location of the vehicle.

In some embodiments, the information of a respective battery service station is selected from the group consisting of: a number of charge stations of the respective battery service station that are occupied, a number of charge stations of the respective battery service station that are free, a number of battery exchange bays of the respective battery service station that are occupied, a number of battery exchange bays of the respective battery service station that are free, a location of the battery service station, and any combination of the aforementioned statuses.

Some embodiments provide a method, a computer readable storage medium, and a system for providing information about battery service stations to vehicles. A vehicle determines a status of a battery of the vehicle and a geographic location of the vehicle. The vehicle includes an electric motor that drives one or more wheels of the vehicle, wherein the electric motor receives energy from the battery. The vehicle then determines from the status of the battery that the battery needs to be recharged. The vehicle determines battery service stations based at least in part on the status of the battery and the geographic location of the vehicle. The vehicle then obtains information about the battery service stations at least in part from a service provider over a data network.

In some embodiments, the vehicle displays the information about the battery service stations on a map in a user interface of a positioning system of the vehicle.

In some embodiments, the vehicle determines from the status of the battery that the battery needs to be recharged includes determining whether a charge level of the battery is below a specified threshold.

In some embodiments, the battery service stations are selected from the group consisting of: charge stations that recharge the one or more batteries of the vehicle, battery exchange stations that replace a spent battery of the vehicle with a charged battery, and any combination of the aforementioned battery service stations.

In some embodiments, the battery is not owned by the user of the vehicle. In these embodiments, the user of the vehicle is selected from the group consisting of: a user that has legal title to the vehicle, and a user that has legal possession of the vehicle as part of a financing agreement for the vehicle.

In some embodiments, the vehicle obtains information about the battery service stations also includes obtaining information about the battery service stations from a positioning system of the vehicle.

In some embodiments, the vehicle periodically receives information about battery service stations from the service provider over the data network.

In some embodiments, the vehicle receives a selection of a battery service station from a user of the vehicle and transmits a request to the service provider to reserve time at the battery service station for the vehicle.

In some embodiments, determining battery service stations based at least in part on the status of the battery and the geographic location of the vehicle includes: determining a maximum distance that the vehicle can travel before the battery can no longer power the electric motor of the vehicle; and selecting the battery service stations within the maximum distance from the geographic location of the vehicle.

In some embodiments, the information of a respective battery service station is selected from the group consisting of: a number of charge stations of the respective battery service station that are occupied, a number of charge stations of the respective battery service station that are free, a number of battery exchange bays of the respective battery service station that are occupied, a number of battery exchange bays of the respective battery service station that are free, a location of the battery service station, and any combination of the aforementioned statuses.

Some embodiments provide a method, a computer readable storage medium, and a system for monitoring battery service stations in a vehicle-area network. A service provider periodically requests a status of a battery service station over a data network. The service provider receives the status of the battery service station over the data network and updates a database that includes information about battery service stations within the vehicle-area network with the status of the battery service station.

In some embodiments, the battery service station is selected from the group consisting of: a charge station that recharges the one or more batteries of the vehicle, a battery exchange station that replaces a spent battery of the vehicle with a charged battery, and any combination of the aforementioned battery service stations.

In some embodiments, the status of the battery service station is selected from the group consisting of: a number of charge stations of the battery service station that are occupied, a number of charge stations of the battery service station that are free, a number of battery exchange bays of the battery service station that are occupied, a number of battery exchange bays of the battery service station that are free, a location of the battery service station, and any combination of the aforementioned statuses.

In some embodiments, the service provider distributes at least a portion of the database that includes information about battery service stations to a vehicle in the vehicle-area network over the data network.

In some embodiments, the at least a portion of the database that includes information about battery service stations is selected based on selection criteria selected from the group consisting of: a geographic location of the vehicle, a charge level of a battery of the vehicle, and any combination of the aforementioned selection criteria.

In some embodiments, periodically requesting the status of the battery service station includes periodically transmitting a query to the battery service station over the data network, wherein the query requests the status of the battery service station.

Some embodiments provide a method, a computer readable storage medium, and a system for reporting a status of a battery service station in a vehicle-area network. A battery service station periodically receives a request for a status of the battery service station from a service provider over a data network. The battery service station determines the status of the battery service station and sends the status of the battery service station to the service provider over the data network.

Some embodiments provide a method, a computer readable storage medium, and a system for providing a vehicle with energy at a battery service station. A battery service station receives a status of a user's account of the vehicle from a service provider over a data network. The battery service station then determines whether the status of the account indicates that the user's account is in good standing. If the status of the account indicates that the user's account is in good standing, the battery service station provides the vehicle with energy at the battery service station. The battery service station then bills the user's account for the energy provided at the battery service station.

In some embodiments, prior to receiving the status of the user's account of the vehicle, the battery service station queries the service provider to determine the account status for the user of the vehicle.

In some embodiments, if the status of the account indicates that the user's account is not in good standing, the battery service station provides options to the user to place the account in good standing.

In some embodiments, the options are selected from the group consisting of: subscribing to a monthly service plan, subscribing to a yearly service plan, subscribing to a mileage-based service plan, subscribing to an energy-consumption-based service plan, subscribing to a pay-per-use plan, and any combination of the aforementioned plans.

In some embodiments, the battery service station is selected from the group consisting of: a charge station that recharges the one or more batteries of the vehicle, a battery exchange station that replaces a spent battery of the vehicle with a charged battery, and any combination of the aforementioned battery service stations.

In some embodiments, determining whether the status of the account indicates that the user's account is in good standing includes one selected from the group consisting of: determining whether a subscription associated with the account is active, determining whether a funding source associated with the account is valid, determining whether a fee for a subscription associated with the account have been paid, and any combination of the aforementioned operations.

In some embodiments, providing the vehicle with energy at the battery service station includes one selected from the group consisting of: providing the vehicle with energy to recharge a battery of the vehicle, and exchanging a spent battery of the vehicle with a charged battery.

Some embodiments provide a method, a computer readable storage medium, and a system for providing account information associated with a vehicle to facilitate providing the vehicle with energy at a battery service station. A service provider receives a query to determine a status of an account of a user of a vehicle from a battery service station over a data network. The service provider then determines the status of the account of the user and sends the status of the account of the user to the battery service station over the data network.

Some embodiments provide a method, a computer readable storage medium, and a system for providing access to battery service stations in a vehicle-area network. A plurality of subscription options for access to battery service stations in a vehicle-area network is provided to a user of a vehicle. The vehicle includes an electric motor that drives one or more wheels of the vehicle, wherein the electric motor receives energy from a battery of the vehicle. Furthermore, the battery is not owned by the user of the vehicle. A selection of a subscription option is received from the user. A contract is entered with the user under terms of the subscription option selected by the user. Information about battery service stations in the vehicle-area network is provided to the user of the vehicle.

In some embodiments, the plurality of subscription options include: subscribing to a monthly service plan, subscribing to a yearly service plan, subscribing to a mileage-based service plan, subscribing to an energy-consumption-based service plan, subscribing to a pay-per-use plan, and any combination of the aforementioned plans.

In some embodiments, access to a battery service station is provided to the user of the vehicle.

In some embodiments, the user is billed for the access to the battery service station based on the contract and services provided at the battery service station.

In some embodiments, the battery service stations are selected from the group consisting of: charge stations that recharge the one or more batteries of the vehicle, battery exchange stations that replace a spent battery of the vehicle with a charged battery, and any combination of the aforementioned battery service stations.

In some embodiments, the user of the vehicle is selected from the group consisting of: a user that has legal title to the vehicle, and a user that has legal possession of the vehicle as part of a financing agreement for the vehicle.

Some embodiments provide a method, a computer readable storage medium, and a system for distributing energy in a power network. Energy from one or more power plants is generated. The energy is distributed through a power network. The energy is stored in batteries of vehicles. A respective vehicle includes a respective electric motor that drives one or more wheels of the respective vehicle, wherein the respective electric motor receives energy from a respective battery of the vehicle. The energy stored in the batteries of the vehicles is extracted when energy production from the one or more power plants is below the demand placed on the power network. The energy extracted from the batteries of the vehicles is distributed to the power network.

In some embodiments, the one or more power plants is selected from the group consisting of: coal power plants, solar power plants, biofuel power plants, nuclear power plants, wind power plants, wave power plants, geothermal power plants, natural gas power plants, fossil fuel power plants, hydroelectric power plants, and any combination of the aforementioned power plants.

In some embodiments, users of vehicles are compensated for the energy extracted from the batteries of the vehicles.

In some embodiments, users of vehicles are charged for the energy stored in the batteries of the vehicles.

Some embodiments provide a vehicle that includes one or more drive wheels, an electric motor, and a battery. The electric motor is coupled to one or more drive wheels of the vehicle, wherein the electric motor is configured to drive the one or more drive wheels. The battery is electrically and mechanically attached to the vehicle, wherein the battery is configured to provide energy to drive the electric motor. In these embodiments, the battery is not owned by the user of the vehicle. Furthermore, the vehicle is owned by a first party and the battery is owned by a second party.

In some embodiments, the user of the vehicle is selected from the group consisting of: a user that has legal title to the vehicle, and a user that has legal possession of the vehicle as part of a financing agreement for the vehicle.

In some embodiments, the first party is selected from the group consisting of: the user of the vehicle, a financial institution, and a service provider.

In some embodiments, the second party is selected from the group consisting of: a financial institution and a service provider.

In some embodiments, the vehicle includes a communications module configured to communicate with a third party.

In some embodiments, the third party provides information about battery service stations to the vehicle.

In some embodiments, the owner of the communication module is selected from the group consisting of: a financial institution a service provider.

### BRIEF DESCRIPTION OF THE DRAWINGS

FIG. 1 illustrates an electric vehicle network, according to some embodiments.

FIG. 2 is a flow diagram of a process for providing information about battery service stations to a user of a vehicle, according to some embodiments.

FIG. 3 is a flow diagram of another process for providing information about battery service stations to a user of a vehicle, according to some embodiments.

FIG. 4 is a flow diagram of another process for providing information about battery service stations to a user of a vehicle, according to some embodiments.

FIG. 5 is a flow diagram of a process for monitoring battery service stations in a vehicle-area network, according to some embodiments.

FIG. 6 is a flow diagram of a process for providing a vehicle with energy at a battery exchange station, according to some embodiments.

FIG. 7 is a flow diagram of a process for providing a vehicle with energy at a charge station, according to some embodiments.

FIG. 8 is a flow diagram of a process for providing access to battery service stations in a vehicle-area network, according to some embodiments.

FIG. 9 is a flow diagram of a process for distributing energy in a power network, according to some embodiments.

FIG. 10 is a flow diagram of a process for establishing a relationship between a user of a vehicle and a service provider, according to some embodiments.

FIG. 11 is a flow diagram of a process for establishing a relationship between a user of a vehicle, a service provider, and a financial institution, according to some embodiments.

FIG. 12 is a flow diagram of another process for establishing a relationship between a user of a vehicle and a service provider, according to some embodiments.

FIG. 13 is a flow diagram of another process for establishing a relationship between a user of a vehicle, a service provider, and a financial institution, according to some embodiments.

FIG. 14 is a flow diagram of another process for establishing a relationship between a user of a vehicle, a service provider, and a financial institution, according to some embodiments.

FIG. 15 is a flow diagram of a process for establishing a relationship between a user of a vehicle and a financial institution, according to some embodiments.

FIG. 16 is a flow diagram of another process for establishing a relationship between a user of a vehicle and a financial institution, according to some embodiments.

FIG. 17 is a block diagram illustrating a vehicle, according to some embodiments.

FIG. 18 is a block diagram illustrating a service provider, according to some embodiments.

FIG. 19 is a block diagram illustrating a battery exchange station, according to some embodiments.

FIG. 20 is a block diagram illustrating a charge station, according to some embodiments.

FIG. 21 illustrates an exemplary user interface of a positioning system of a vehicle, according to some embodiments.

Like reference numerals refer to corresponding parts throughout the drawings.

### DESCRIPTION OF EMBODIMENTS

### Electric Vehicle Network

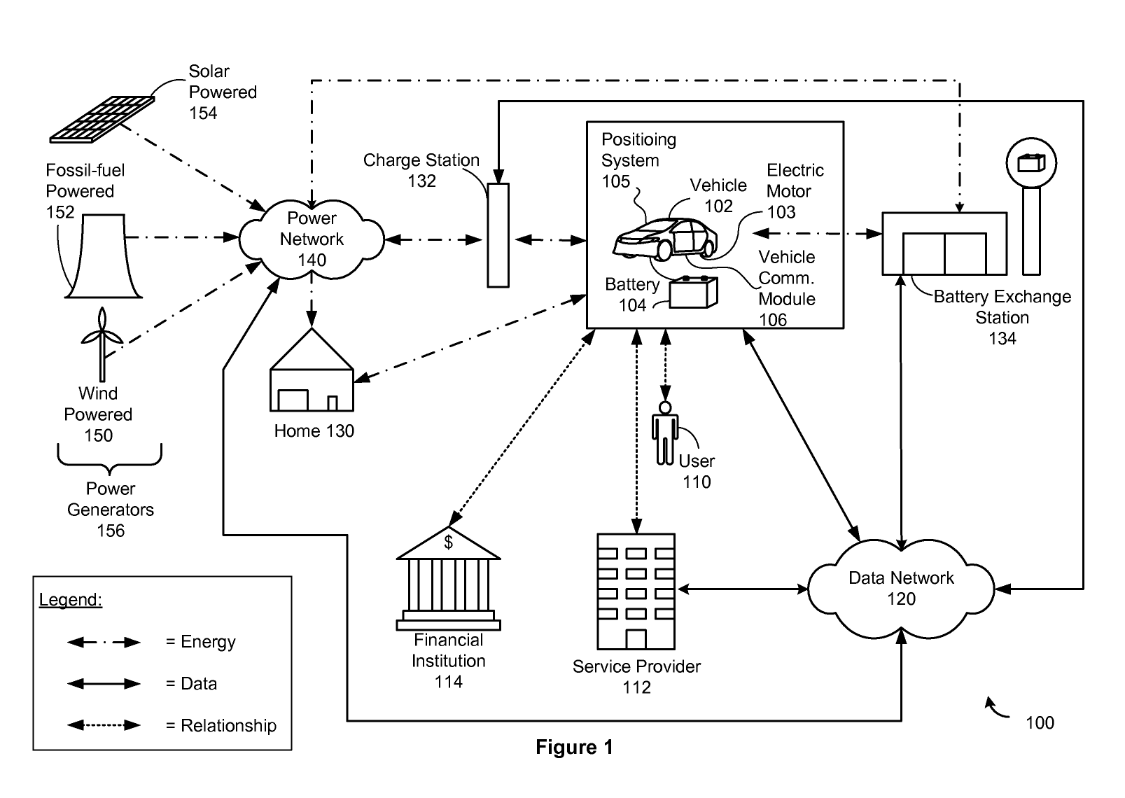

FIG. 1 illustrates an electric vehicle network 100, according to some embodiments. The electric vehicle network 100 includes a vehicle 102 and a battery 104. In some embodiments, the battery 104 includes any device capable of storing electric energy such as batteries (e.g., lithium ion batteries, lead-acid batteries, nickel-metal hydride batteries, etc.), capacitors, reaction cells (e.g., Zn-air cell), etc.

In some embodiments, the vehicle 102 includes an electric motor 103 that drives one or more wheels of the vehicle. In these embodiments, the electric motor 103 receives energy from a battery (e.g., the battery 104) that is electrically and mechanically attached to the vehicle (shown separate from the vehicle for the ease of explanation). The battery 104 of the vehicle 102 may be charged at a home 130 of a user 110. Alternatively, the battery 104 of the vehicle 102 may be charged at one or more charge stations 132. For example, a charge station 132 may be located in a shopping center parking lot. Furthermore, in some embodiments, the battery 104 of the vehicle 102 can be exchanged for a charged battery at one or more battery exchange stations 134. Thus, if a user is traveling a distance beyond the range of a single charge of the battery of the vehicle, the spent (or partially spent) battery can be exchanged for a charged battery so that the user can continue with his/her travels without waiting for the battery to be recharged. The term “battery service station” is used herein to refer to battery exchange stations, which exchange spent (or partially spent) batteries of the vehicle for charged batteries, and/or charge stations, which provide energy to charge the battery of the vehicle. Furthermore, the term “charge spot” can refer to a “charge station.”

In some embodiments, the vehicle 102 includes a communication module 106, including hardware and software, that is used to communicate with a service provider 112 of a vehicle-area network. Note that the term “vehicle-area network” is used herein to refer to a network of vehicles, batteries, battery exchange stations, charge stations, and a data network. In some embodiments, the vehicle communication module 106 is owned by the user 110 of the vehicle 102, a financial institution 114, and/or the service provider 112.

In some embodiments, the vehicle 102 includes a positioning system 105. For example, the positioning system can include: a satellite positioning system, a radio tower positioning system, a Wi-Fi positioning system, and any combination of the aforementioned positioning systems. Furthermore, the positioning system 105 may include a navigation system that generates routes and/or guidance between a geographic location and a destination.

In some embodiments, the battery is not owned by the user 110 of the vehicle 102. In these embodiments, the user 110 of the vehicle 102 is a user that has legal title to the vehicle or a user that has legal possession of the vehicle, such as when in possession as part of a financing agreement for the vehicle (e.g., a loan or a lease).

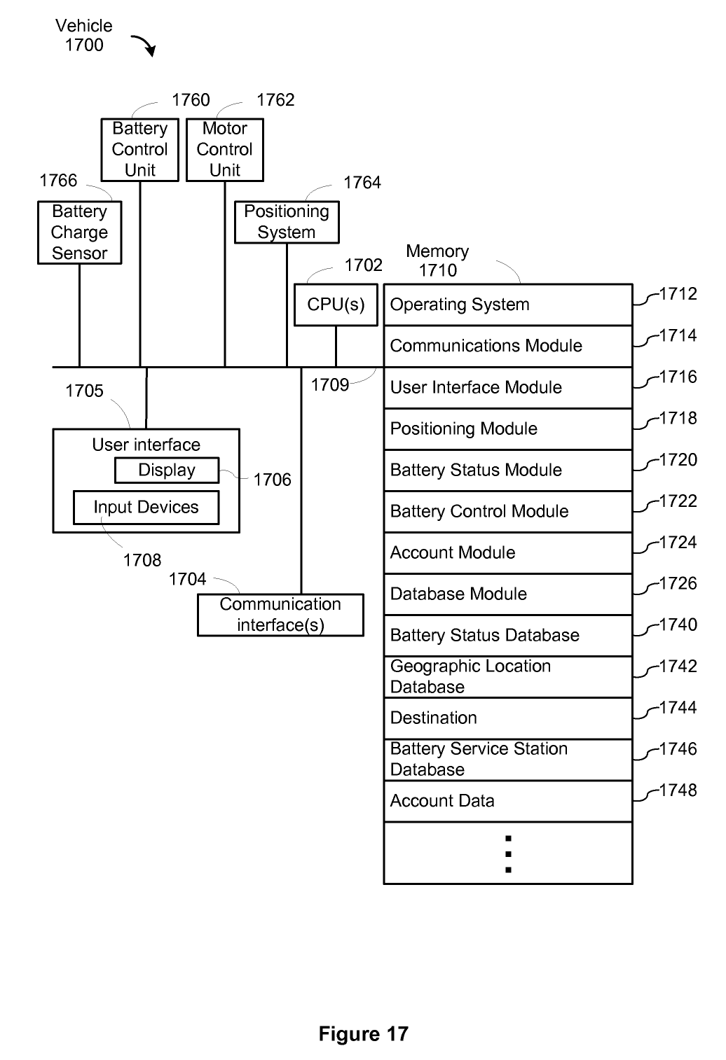

FIG. 17 is a block diagram illustrating a vehicle 1700 in accordance with some embodiments. For example, the vehicle 1700 can be the vehicle 102 in FIG. 1. The vehicle 1700 typically includes one or more processing units (CPU's) 1702, one or more network or other communications interfaces 1704 (e.g., antennas, I/O interfaces, etc.), memory 1710, a battery control unit that controls the charging of a battery of the vehicle and/or the exchanging of a partially spent battery for a charged battery, a motor control unit 1762 that manages the electric motor 103, a positioning system 1764 (e.g., the positioning system 105 in FIG. 1), a battery charge sensor that determines the status of the battery 104 as described herein, and one or more communication buses 1709 for interconnecting these components. The communication buses 1709 may include circuitry (sometimes called a chipset) that interconnects and controls communications between system components. The vehicle 1700 optionally may include a user interface 1705 comprising a display device 1706 and input devices 1708 (e.g., a mouse, a keyboard, a touchpad, a touch screen, etc.). Memory 1710 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1710 may optionally include one or more storage devices remotely located from the CPU(s) 1702. Memory 1710, or alternately the non-volatile memory device(s) within memory 1710, comprises a computer readable storage medium. In some embodiments, memory 1710 stores the following programs, modules and data structures, or a subset thereof:
an operating system 1712 that includes procedures for handling various basic system services and for performing hardware dependent tasks;
a communication module 1714 (e.g., the vehicle communication module 106) that is used for connecting the vehicle 1700 to other computers via the one or more communication network interfaces 1704 (wired or wireless) and one or more communication networks, such as the Internet, other wide area networks, local area networks, metropolitan area networks, and so on;
a user interface module 1716 that receives commands from the user via the input devices 1708 and generates user interface objects in the display device 1706;
a positioning module 1718 that determines the position of the vehicle 1700 using a positioning system as described herein, and that includes a destination 1744 that is selected by the user of the vehicle;
a battery status module 1720 that determines the status of a battery of a vehicle;
a battery control module 1722 that controls the charging of a battery of the vehicle and/or the exchanging of a partially spent battery for a charged battery, wherein the battery control module includes handshaking and encryption functions that are used during communication between the vehicle 1700 and battery service stations and/or the service provider 112;
an account module 1724 that manages account information for the user of the vehicle;
a database module 1726 that interfaces with database in the vehicle 1700;
battery status database 1740 that includes present and/or historical information about the status of the battery of the vehicle;
a geographic location database 1742 of the vehicle that stores the present location and/or historical locations and addresses;
a battery service station database 1746 that includes information about battery service stations; and
account data 1748 that includes account information for the user of the vehicle.

Note that the positioning system 105 (and the positioning system 1764), the vehicle communication module 106, the user interface module 1716, the positioning module 1718, the battery status module 1720, the battery control module 1722, the account module 1724, the database module 1726, the battery status database 1740, the geographic location database 1742, and the battery service station database 1746 can be referred to as the “vehicle operating system.”

Each of the above identified elements may be stored in one or more of the previously mentioned memory devices, and corresponds to a set of instructions for performing a function described above. The set of instructions can be executed by one or more processors (e.g., the CPUs 1702). The above identified modules or programs (i.e., sets of instructions) need not be implemented as separate software programs, procedures or modules, and thus various subsets of these modules may be combined or otherwise re-arranged in various embodiments. In some embodiments, memory 1710 may store a subset of the modules and data structures identified above. Furthermore, memory 1710 may store additional modules and data structures not described above.

Note that although a single vehicle is discusses herein, the methods and systems can be applied to a plurality of vehicles.

In some embodiments, the service provider 112 provides information regarding battery service stations via the vehicle communication module 106. The service provider 112 also provides access to the battery service stations to the vehicle 102. The service provider 112 obtains information about the vehicles and/or battery service stations by sending queries through a data network 120 to the vehicle 102, the charge station 132, and/or the battery exchange station 134. For example, the service provider 112 can query the vehicle 102 to determine a geographic location of the vehicle and a status of a battery of the vehicle. Similarly, the service provider 112 can query the charge station 132 (and/or the battery exchange station 134) to determine the status of the charge station 132 (and/or the battery exchange station 134). The status of a battery service station can include: a number of charge stations of the respective battery service station that are occupied, a number of charge stations of the respective battery service station that are free, an estimated time until charge completion for respective vehicles charging at respective charge stations, a number of battery exchange bays of the respective battery service station that are occupied, a number of battery exchange bays of the respective battery service station that are free, a number of charged batteries available at the respective battery service station, a number of spent batteries at the respective battery service station, types of batteries available at the respective battery service station, an estimated time until a respective spent battery is recharged, an estimated time until a respective exchange bay will become free, a location of the battery service station, and any combination of the aforementioned statuses. The service provider 112 can also send information and/or commands through the data network to the vehicle 102, the charge station 132, and/or the battery exchange station 134. For example, the service provider 112 can send information about a status of an account of a user, the locations of battery service stations, and/or a status of the battery service stations.

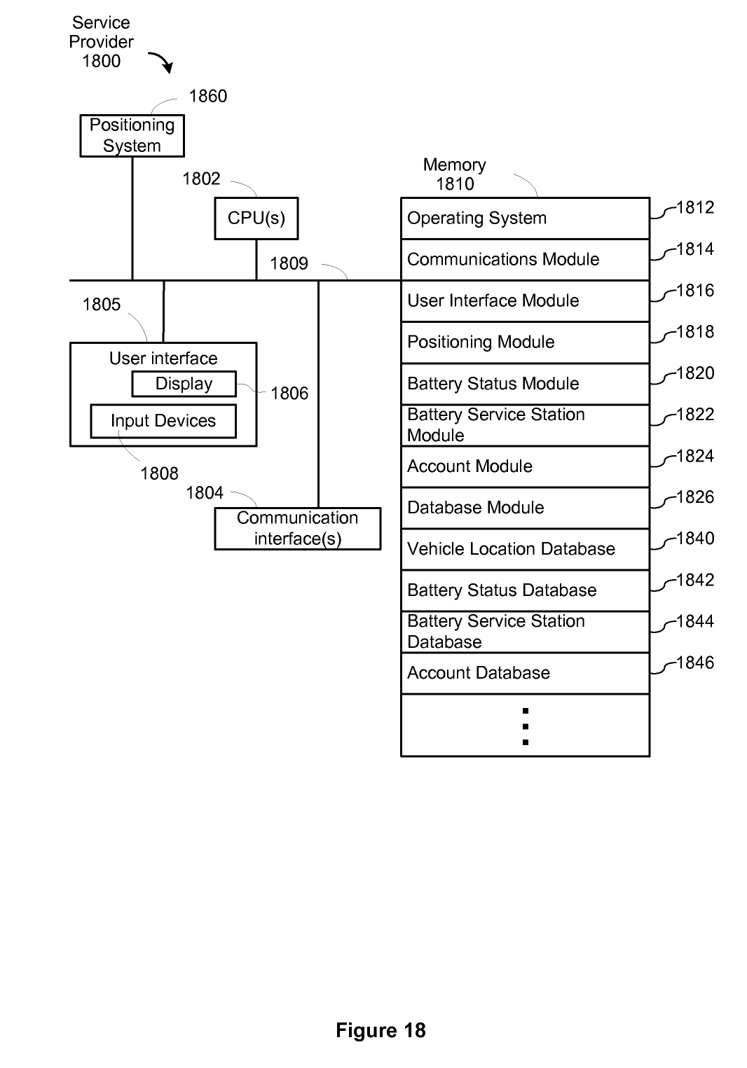

FIG. 18 is a block diagram illustrating a service provider 1800 in accordance with some embodiments. For example, the service provider 1800 can be the service provider 112 in FIG. 1. The service provider 1800 can be a computer system of a service provider. The service provider 1800 typically includes one or more processing units (CPU's) 1802, one or more network or other communications interfaces 1804 (e.g., antennas, I/O interfaces, etc.), memory 1810, a positioning system 1860 that tracks the position of vehicles and battery service stations using a positioning system, and one or more communication buses 1809 for interconnecting these components. The communication buses 1809 are similar to the communication buses 1709 described above. The service provider 1800 optionally may include a user interface 1805 comprising a display device 1806 and input devices 1808 (e.g., a mouse, a keyboard, a touchpad, a touch screen, etc.). Memory 1810 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1810 may optionally include one or more storage devices remotely located from the CPU(s) 1802. Memory 1810, or alternately the non-volatile memory device(s) within memory 1810, comprises a computer readable storage medium. In some embodiments, memory 1810 stores the following programs, modules and data structures, or a subset thereof:
an operating system 1812 that includes procedures for handling various basic system services and for performing hardware dependent tasks;
a communication module 1814 that is used for connecting the service provider 1800 to other computing devices via the one or more communication network interfaces 1804 (wired or wireless) and one or more communication networks, such as the Internet, other wide area networks, local area networks, metropolitan area networks, and so on;
a user interface module 1816 that receives commands from the user via the input devices 1808 and generates user interface objects in the display device 1806;
a positioning module 1818 that tracks the position of vehicles and battery service stations using a positioning system as described herein;
a battery status module 1820 that determines the status of a battery of a vehicle;
a battery service station module 1822 that tracks the status of battery service stations;
an account module 1824 that manages account information for the user of the vehicle;
a database module 1826 that interfaces with database in the service provider 1800;
a vehicle location database 1840 that includes the present and/or historical locations of vehicles in the vehicle-area network;
a battery status database 1842 that includes the status of batteries in the vehicle-area network;
a battery service station database 1844 that includes the status of battery service stations in the vehicle-area network; and
account data 1846 that includes account information for the user of the vehicle.

Each of the above identified elements may be stored in one or more of the previously mentioned memory devices, and corresponds to a set of instructions for performing a function described above. The set of instructions can be executed by one or more processors (e.g., the CPUs 1802). The above identified modules or programs (i.e., sets of instructions) need not be implemented as separate software programs, procedures or modules, and thus various subsets of these modules may be combined or otherwise re-arranged in various embodiments. In some embodiments, memory 1810 may store a subset of the modules and data structures identified above. Furthermore, memory 1810 may store additional modules and data structures not described above.

In some embodiments, the battery exchange station 134 exchanges a spent (or a partially spent) battery (e.g., the battery 104) of a vehicle (e.g., the vehicle 102) with a charged battery. In these embodiments, instead of charging the battery of the vehicle, the battery is swapped-out for a fully charged battery. After extracting the battery from the vehicle, the battery exchange station 134 may recharge the partially spent battery. Thus, just as a gasoline station can quickly refill the gas tank of a gasoline-powered vehicle, the battery exchange station 134 can quickly swap-out a depleted or partially spent battery of the vehicle for a charged battery.

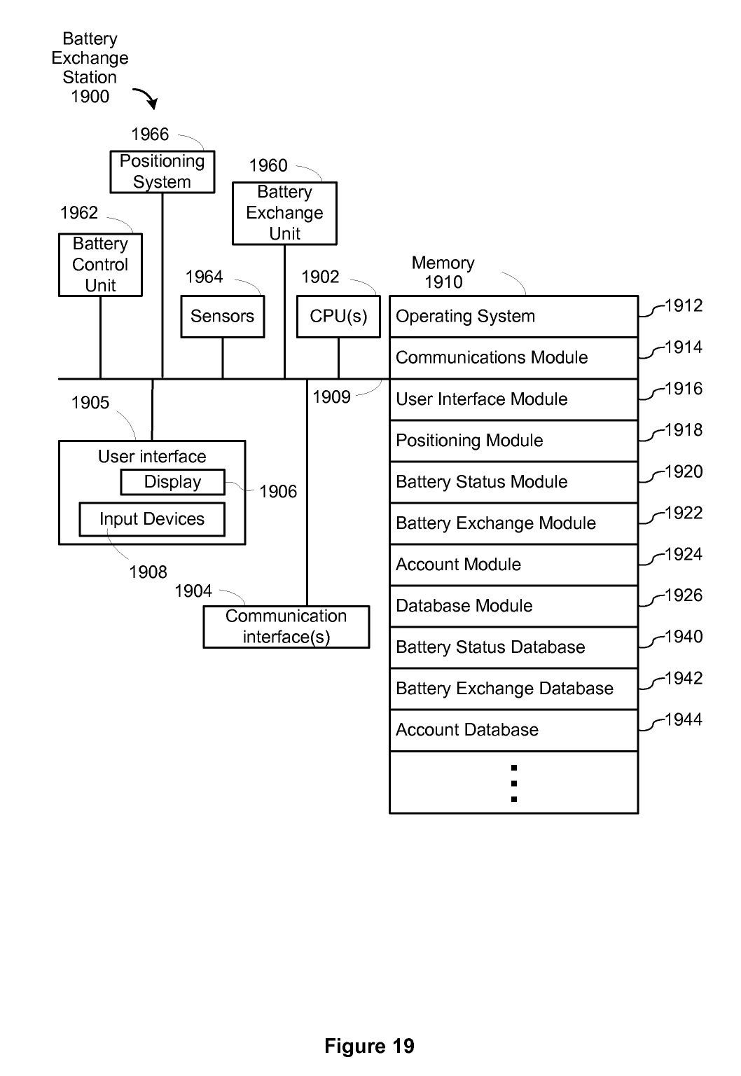

FIG. 19 is a block diagram illustrating a battery exchange station 1900 in accordance with some embodiments. For example, the battery exchange station 1900 can be the battery exchange station 134 in FIG. 1. The battery exchange station 1900 can be a computer system of a battery exchange station. The battery exchange station 1900 typically includes one or more processing units (CPU's) 1902, one or more network or other communications interfaces 1904 (e.g., antennas, I/O interfaces, etc.), memory 1910, a battery exchange unit 1960 that exchanges batteries of vehicles, a battery control unit 1962 that manages the charging of spent batteries that are extracted from vehicle, sensors 1964 that determine the status of the battery exchange station 1900, a positioning module 1966 that determines and/or reports the position of the battery exchange station 1900, and one or more communication buses 1909 for interconnecting these components. The communication buses 1909 are similar to the communication buses 1709 described above. The battery exchange station 1900 optionally may include a user interface 1905 comprising a display device 1906 and input devices 1908 (e.g., a mouse, a keyboard, a touchpad, a touch screen, etc.). Memory 1910 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1910 may optionally include one or more storage devices remotely located from the CPU(s) 1902. Memory 1910, or alternately the non-volatile memory device(s) within memory 1910, comprises a computer readable storage medium. In some embodiments, memory 1910 stores the following programs, modules and data structures, or a subset thereof:
an operating system 1912 that includes procedures for handling various basic system services and for performing hardware dependent tasks;
a communication module 1914 that is used for connecting the battery exchange station 1900 to other computers via the one or more communication network interfaces 1904 (wired or wireless) and one or more communication networks, such as the Internet, other wide area networks, local area networks, metropolitan area networks, and so on;
a user interface module 1916 that receives commands from the user via the input devices 1908 and generates user interface objects in the display device 1906;
a positioning module 1918 that determines (e.g., via a positioning system as described herein, via user input, etc.) and/or reports the position of a battery exchange station using a positioning system as described herein;
a battery status module 1920 that determines the status of batteries located at the battery exchange station;
a battery exchange module 1922 that determines and reports the status of the battery exchange station 1900 and performs operations related to exchange batteries of vehicles as described herein;
an account module 1924 that manages account information of users of vehicles;
a database module 1926 that interfaces with database in the battery exchange station 1900;
a battery status database 1940 that includes the status of batteries in the battery exchange station;
a battery exchange database 1942 that includes the status of batteries and/or battery exchange bays in the battery exchange station; and
account data 1944 that includes account information of users of vehicles.

Each of the above identified elements may be stored in one or more of the previously mentioned memory devices, and corresponds to a set of instructions for performing a function described above. The set of instructions can be executed by one or more processors (e.g., the CPUs 1902). The above identified modules or programs (i.e., sets of instructions) need not be implemented as separate software programs, procedures or modules, and thus various subsets of these modules may be combined or otherwise re-arranged in various embodiments. In some embodiments, memory 1910 may store a subset of the modules and data structures identified above. Furthermore, memory 1910 may store additional modules and data structures not described above.

In some embodiments, the charge station 132 provides energy to the vehicle to charge the battery 104 of the vehicle 102. Charge stations can be placed at locations where vehicles may be parked. For example, the charge stations can be located in a parking lots and/or street parking spots. In some embodiments, a charge station can be located at a home of a user (e.g., the home 130). In some embodiments, the charge station 132 may charge the battery 104 of the vehicle 102 at different rates. For example, the charge station 132 may charge the battery 104 of the vehicle 102 using a quick-charge mode or a trickle charge mode.

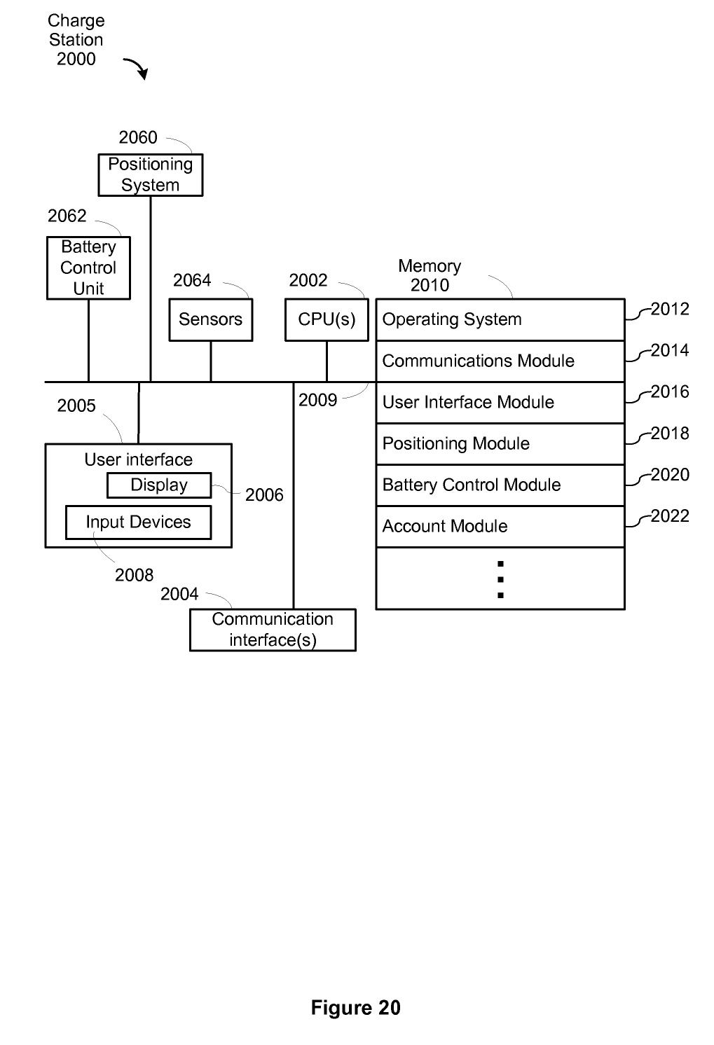

FIG. 20 is a block diagram illustrating a charge station 2000 in accordance with some embodiments. For example, the charge station 2000 can be the charge station 132 in FIG. 1. The charge station 2000 can be a computer system of a charge station. The charge station 2000 typically includes one or more processing units (CPU's) 2002, one or more network or other communications interfaces 2004 (e.g., antennas, I/O interfaces, etc.), memory 2010, a positioning system 2060 that determines and/or reports the position of the charge station 2000, a battery control unit 2062 that charges batteries at the charge station 2000, sensors 2064 that determine the status of the charge station 2000, and one or more communication buses 2009 for interconnecting these components. The communication buses 2009 are similar to the communication buses 1709 described above. The charge station 2000 optionally may include a user interface 2005 comprising a display device 2006 and input devices 2008 (e.g., a mouse, a keyboard, a touchpad, a touch screen, etc.). Memory 2010 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 2010 may optionally include one or more storage devices remotely located from the CPU(s) 2002. Memory 2010, or alternately the non-volatile memory device(s) within memory 2010, comprises a computer readable storage medium. In some embodiments, memory 2010 stores the following programs, modules and data structures, or a subset thereof:
an operating system 2012 that includes procedures for handling various basic system services and for performing hardware dependent tasks;
a communication module 2014 that is used for connecting the charge station 2000 to other computers via the one or more communication network interfaces 2004 (wired or wireless) and one or more communication networks, such as the Internet, other wide area networks, local area networks, metropolitan area networks, and so on;
a user interface module 2016 that receives commands from the user via the input devices 2008 and generates user interface objects in the display device 2006;
a positioning module 2018 that determines (e.g., via a positioning system as described herein, via user input, etc.) and/or reports the position of a battery exchange station using a positioning system as described herein;
a battery control module 2020 that determines and reports the status of the charge station 2000 and that performs operations related to charging batteries at a charge station as described herein; and
an account module 2022 that manages account information of users of vehicles.

Each of the above identified elements may be stored in one or more of the previously mentioned memory devices, and corresponds to a set of instructions for performing a function described above. The set of instructions can be executed by one or more processors (e.g., the CPUs 2002). The above identified modules or programs (i.e., sets of instructions) need not be implemented as separate software programs, procedures or modules, and thus various subsets of these modules may be combined or otherwise re-arranged in various embodiments. In some embodiments, memory 2010 may store a subset of the modules and data structures identified above. Furthermore, memory 2010 may store additional modules and data structures not described above.

Although FIGS. 17-20 each show a respective computer system, FIGS. 17-20 are intended more as functional description of the various features which may be present in a set of computer systems than as a structural schematic of the embodiments described herein. In practice, and as recognized by those of ordinary skill in the art, items shown separately could be combined and some items could be separated. For example, some items shown separately in FIGS. 17-20 could be implemented on single computer systems and single items could be implemented by one or more computer systems. The actual number of computer systems used to implement a respective computer system and how features are allocated among them will vary from one implementation to another, and may depend in part on the amount of data traffic that the system must handle during peak usage periods as well as during average usage periods.

The electric vehicle network 100 shown in FIG. 1 also includes the data network 120 and a power network 140.

The data network 120 may include any type of wired or wireless communication network capable of coupling together computing nodes. This includes, but is not limited to, a local area network, a wide area network, or a combination of networks. In some embodiments, the data network 120 is a wireless data network including: a cellular network, a Wi-Fi network, a WiMAX network, an EDGE network, a GPRS network, an EV-DO network, an RTT network, a HSPA network, a UTMS network, a Flash-OFDM network, an iBurst network, and any combination of the aforementioned networks. In some embodiments, the data network 120 includes the Internet.

As illustrated in FIG. 1, the data network 120 is coupled to the vehicle 102, the service provider 112, the charge station 132, and the battery exchange station 134. Note that for the sake of clarity, only one vehicle, one battery, one charge station and one battery exchange station is illustrated, but the electric vehicle network 100 may include any number of vehicles, batteries, charge stations, and/or battery exchange stations, etc. Furthermore, the electric vehicle network 100 may include zero or more charge stations and/or battery exchange stations. For example, the electric vehicle network 100 may only include charge stations. On the other hand, the electric vehicle network 100 may only include battery exchange stations. In some embodiments, any of the vehicle 102, the service provider 112, the charge station 132, and/or the battery exchange station 134 includes a communication module that can be used to communicate with each other through the data network 120.

The power network 140 can include power generators 156, power transmission lines, power substations, transformers, etc., which facilitate the generation and transmission. The power generators 156 may include any type of energy generation plants, such as wind-powered plants 150, fossil-fuel powered plants 152, solar powered plants 154, biofuel powered plants, nuclear powered plants, wave powered plants, geothermal powered plants, natural gas powered plants, hydroelectric powered plants, and a combination of the aforementioned power plants or the like. The energy generated by the one or more power generators 156 may be distributed through the power network 140 to homes 130, charge stations 132, and/or battery exchange stations 134. The power network 140 can also include batteries such as the battery 104 of the vehicle 102, batteries at battery exchange stations, and/or batteries that are not associated with vehicles. Thus, energy generated by the power generators 156 can be stored in these batteries and extracted when energy demand exceed energy generation.

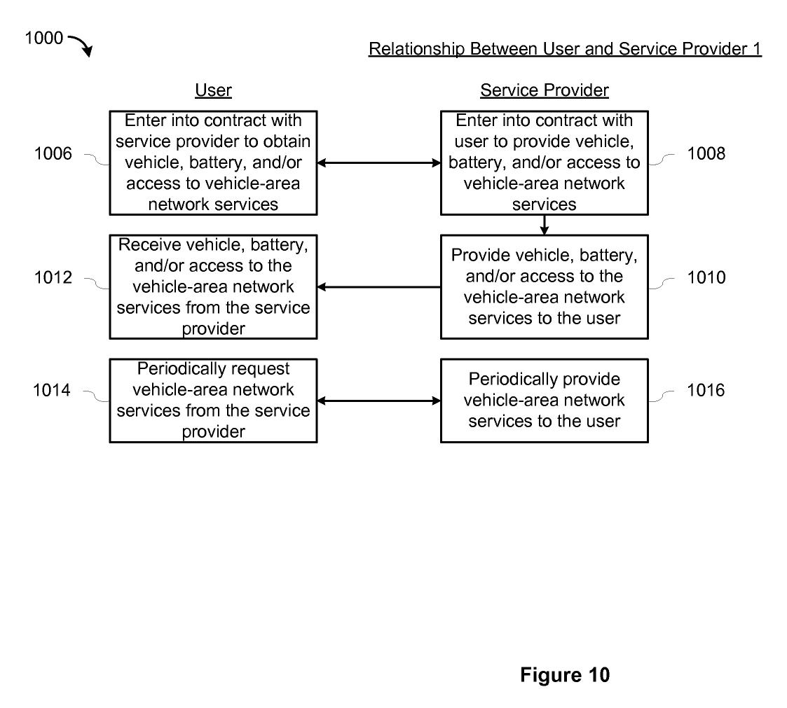

As illustrated in FIG. 1, a number of relationships exist between the vehicle 102, the battery 104, the user 110, the service provider 112, the financial institution 114, and the power network 140. In some embodiments, the financial institution 114 may own the vehicle 102, the battery 104, and/or a vehicle-area network. In some embodiments, the service provider 112 owns the vehicle 102, the battery 104, and/or the vehicle-area network. In some embodiments, the user 110 owns the vehicle 102, but does not own the battery 104. In some embodiments, the user 110 owns both the vehicle 102 and the battery 104. In some embodiments, the user does not own either the battery 104 or the vehicle 102. In these embodiments, the user can lease/rent the vehicle from the service provider 112 and/or the financial institution 114. These relationships are described in more detail below with respect to FIGS. 10-16.

Providing Information about Battery Service Stations

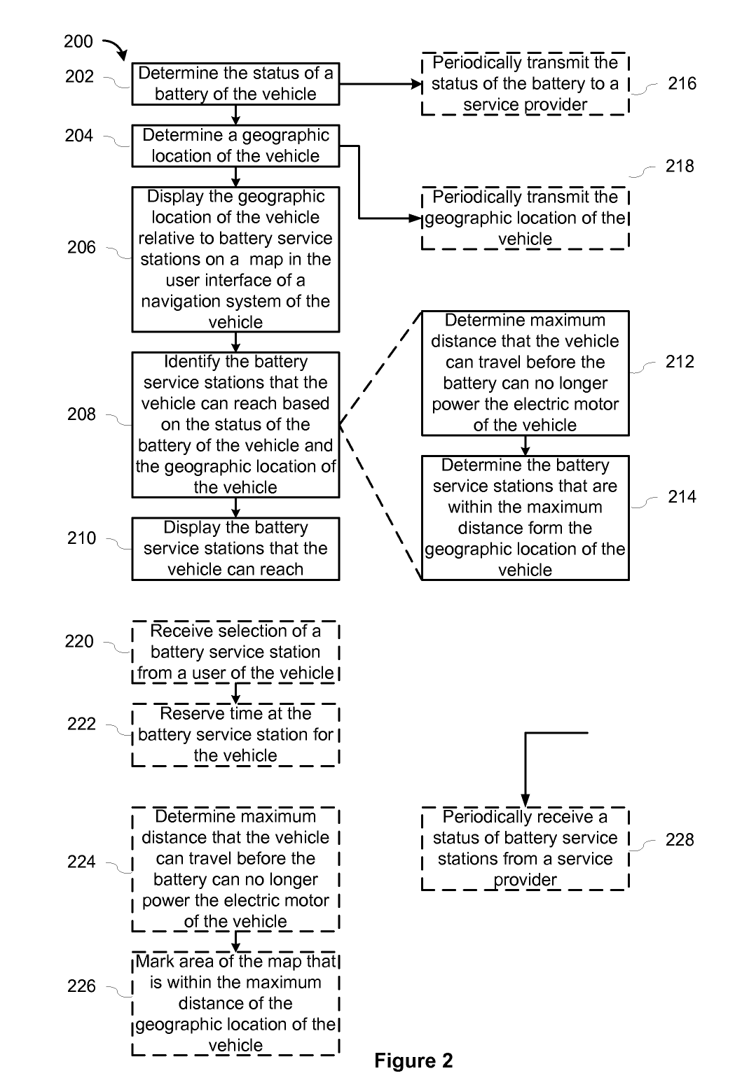

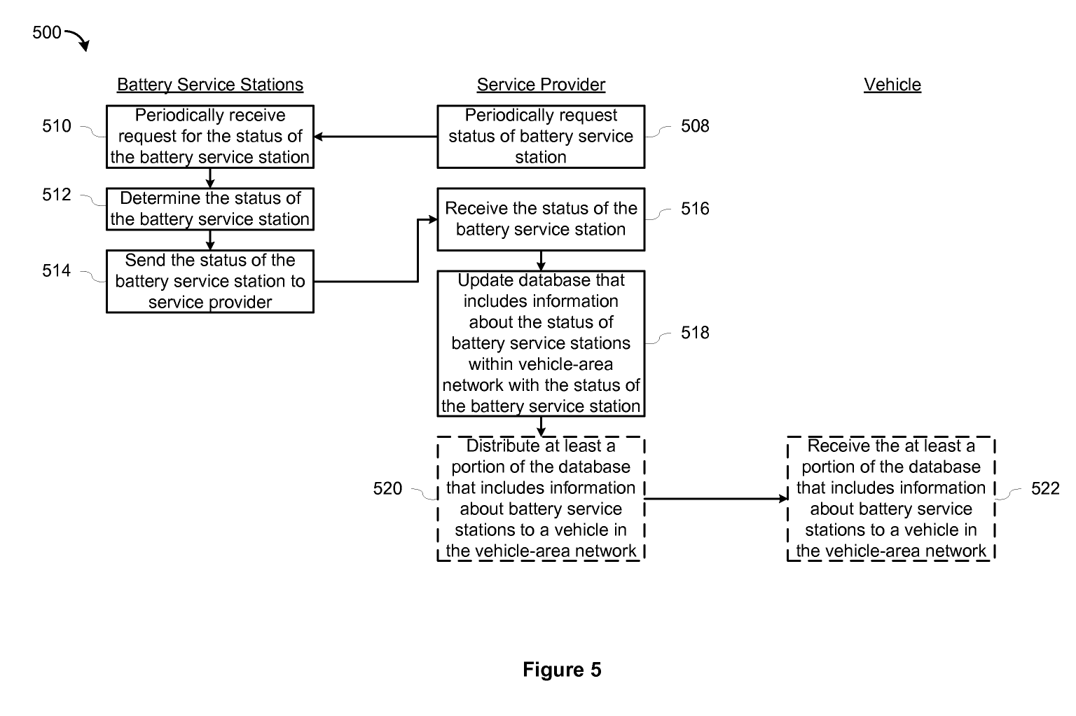

In the methods described in FIGS. 2-16, the respective methods may be governed by instructions that are stored in a computer readable storage medium and that are executed by one or more processors of one or more computer systems. Each of the operations shown in FIGS. 2-16, respectively, may correspond to instructions stored in a computer memory or computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors.

FIG. 2 is a flowchart representing a method 200 for providing information about battery service stations to a user of a vehicle, according to some embodiments. In some embodiments, the method 200 is performed at the vehicle. The method 200 begins when the battery status module 1720 of the vehicle determines (202) a status of a battery of the vehicle. In some embodiments, determining the status of the battery of the vehicle includes determining a charge level of the battery, determining an age of the battery, determining the number of charge/discharge cycles of the battery, and a combination of the aforementioned operations. In some embodiments, the vehicle periodically transmits (216) the status of the battery of the vehicle to a service provider over a data network.

The positioning module 1718 of the vehicle then determines (204) a geographic location of the vehicle. In some embodiments, the positioning system includes: a satellite positioning system, a radio tower positioning system, a Wi-Fi positioning system, and any combination of the aforementioned positioning systems. In some embodiments, the vehicle periodically transmits (218) the geographic location of the vehicle to a service provider over a data network.

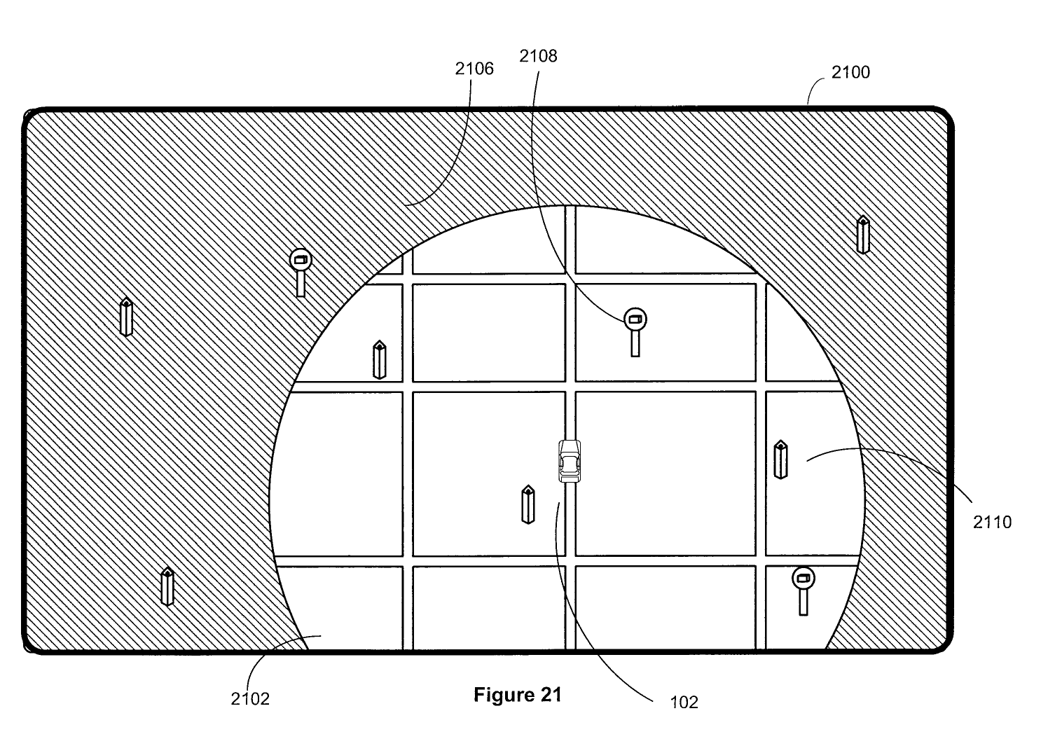

The user interface module 1716 of the vehicle then displays (206) the geographic location of the vehicle relative to battery service stations on a map in the user interface 1705 of the positioning system 1764 of the vehicle. As mentioned above, the battery service stations include: charge stations that recharge the one or more batteries of the vehicle, battery exchange stations that replace a spent battery of the vehicle with a charged battery, and any combination of the aforementioned battery service stations. For example, FIG. 21 illustrates an exemplary user interface 2100 of the positioning system 1764 of the vehicle 102, according to some embodiments. As illustrated in FIG. 21, a highlighted area 2102 indicates an area that the vehicle 102 can reach based on the charge status of the battery 104. The shaded area 2106 indicates areas which the vehicle 102 cannot reach based on the charge status of the battery 104. A number of charge stations 132 and battery exchange stations 2108 are displayed in the user interface 2100.

The positioning module 1718 in the vehicle identifies (208) the battery service stations that the vehicle can reach based on the status of the battery of the vehicle and the geographic location of the vehicle. In some embodiments, identifying the battery service stations that the vehicle can reach based on the status of the battery of the vehicle includes: determining (212) a maximum distance that the vehicle can travel before the battery can no longer power the electric motor of the vehicle and determining (214) the battery service stations that are within the maximum distance from the geographic location of the vehicle. In some embodiments, the maximum distance includes a specified safety factor (e.g., a 20% margin is added to the maximum distance). In some embodiments, the battery service stations are identified by a service provider and/or the positioning module 1718 of the vehicle.

In some embodiments, the positioning system notifies the user of the battery service stations that the vehicle can reach. For example, the user interface 1705 of the positioning system 1764 in the vehicle may display (210) the battery service stations that the vehicle can reach on the map.

In some embodiments, the positioning module 1718 of the vehicle determines (224) a maximum distance that the vehicle can travel before the battery can no longer power the electric motor of the vehicle and displays (226) an area of the map that is within the maximum distance of the geographic location of the vehicle. For example, the area that the vehicle can reach can be highlighted, circled, etc. Alternatively or in addition, the area that the vehicle cannot reach may be shaded.

The user of the vehicle may then select a particular battery service station from those displayed to have the battery of the vehicle recharged or exchanged. Thus, in some embodiments, the vehicle receives (220) a selection of a battery service station from a user of the vehicle and reserves (222) time at the battery service station for the vehicle. The positioning module 1718 of the vehicle may then generate a route from the geographic location of the vehicle to the selected battery service station.

In some embodiments, the vehicle periodically receives (228) the status of the one or more battery service stations from the service provider over the data network. The status of a respective battery service station can include: a number of charge stations of the respective battery service station that are occupied, the number of charge stations of the respective battery service station that are available or free, an estimated time until charge completion for respective vehicles charging at respective charge stations, the number of battery exchange bays of the respective battery service station that are occupied, the number of battery exchange bays of the respective battery service station that are unoccupied or free, the number of charged batteries available at the respective battery service station, whether a suitable/compatible battery is available at the respective battery service station, an estimated time until a respective spent battery is recharged, an estimated time until a respective exchange bay will become free, a location of the battery service station, and any combination of the aforementioned statuses.

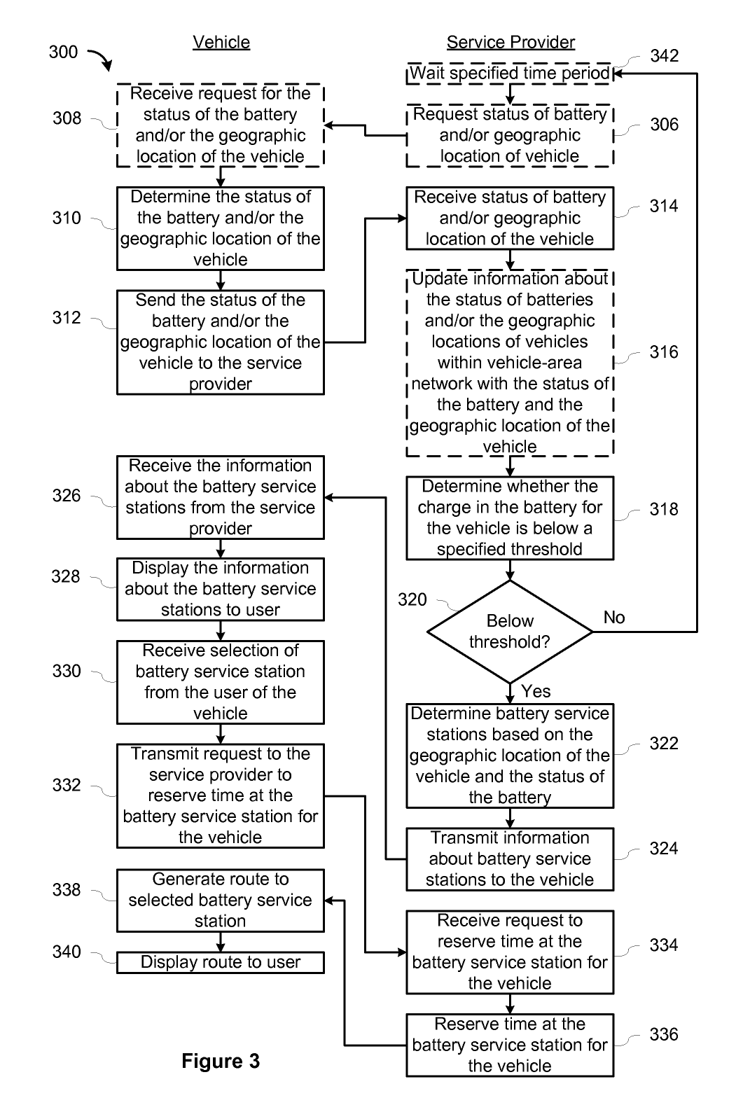

FIG. 3 is a flowchart representing a method 300 for providing information about battery service stations to a user of the vehicle 102, according to some embodiments. The method 300 begins when the service provider 112 receives (314) a status of a battery of the vehicle 102 and a geographic location of the vehicle 102 from the vehicle 102 over the data network 120.

In some embodiments, prior to receiving the status of the battery of the vehicle 102 and the geographic location of the vehicle 102 from the vehicle 102 over the data network 120, the service provider 112 requests (306) the status of the battery of the vehicle 102 and/or the geographic location from the vehicle 102 over the data network 120. The vehicle 102 receives (308) the request for the status of the battery and/or the geographic location of the vehicle 102. The battery status module 1720 of the vehicle 102 then determines (310) the status of the battery and/or the positioning module 1718 determines the geographic location of the vehicle (e.g., using the positioning systems described above). The vehicle 102 then sends (312) the status of the battery and/or the geographic location of the vehicle 102 to the service provider 112.

In some embodiments, the battery status module 1820 of the service provider 112 updates (316) the battery status database 1842, which includes information about the status of batteries, with the status of the battery and/or the positioning module 1818 of the service provider 112 updates the vehicle location database 1840, which includes the geographic locations of vehicles within a vehicle-area network, with the geographic location of the vehicle 102.

The battery status module 1820 of the service provider 112 then determines from the status of the battery that the battery needs to be recharged. For example, the battery status module 1820 of the service provider 112 can determine (318) whether a charge level of the battery is below a specified threshold. If the battery does not need to be recharged (320, No), the service provider 112 waits (342) a specified time period before the method returns to step 306. If the battery needs to be recharged (320, Yes), the positioning module 1818 of the service provider 112 determines (322) suitable battery service stations based at least in part on the status of the battery and the geographic location of the vehicle 102. In some embodiments, determining battery service stations based at least in part on the status of the battery and the geographic location of the vehicle includes: determining a maximum distance that the vehicle can travel before the battery can no longer power the electric motor of the vehicle, and selecting the battery service stations within the maximum distance from the geographic location of the vehicle.

The service provider 112 then transmits (324) information about the battery service stations to the vehicle 102 over the data network 120. In some embodiments, the service provider 112 periodically transmits information about battery service stations to the vehicle 102 over the data network 120. The vehicle 102 receives (326) the information about the battery service stations from the service provider 112 and displays (328) the information about the battery service stations to the user on the user interface 1705 of the positioning system 1764. In some embodiments, the information about the battery service stations is displayed on a map in a user interface 1705 of the positioning system 1764 of the vehicle 102.

The vehicle 102 can then receive (330) a selection of a battery service station from the user of the vehicle 102. The vehicle 102 transmits (332) a request to the service provider 112 to reserve time at the battery service station for the vehicle 102. The service provider 112 receives (334) a selection of a battery service station from the user of the vehicle 102 over the data network and reserves (336) a time slot or time at the battery service station for the vehicle 102.

The vehicle 102 then generates (338) a route to the selected battery service station and displays (340) the route to the user. In some embodiments, the positioning module 1718 of the vehicle 102 guides the user to the selected battery service station. For example, visual and/or audio route guidance can be provided by the positioning module 1718 of the vehicle 102.

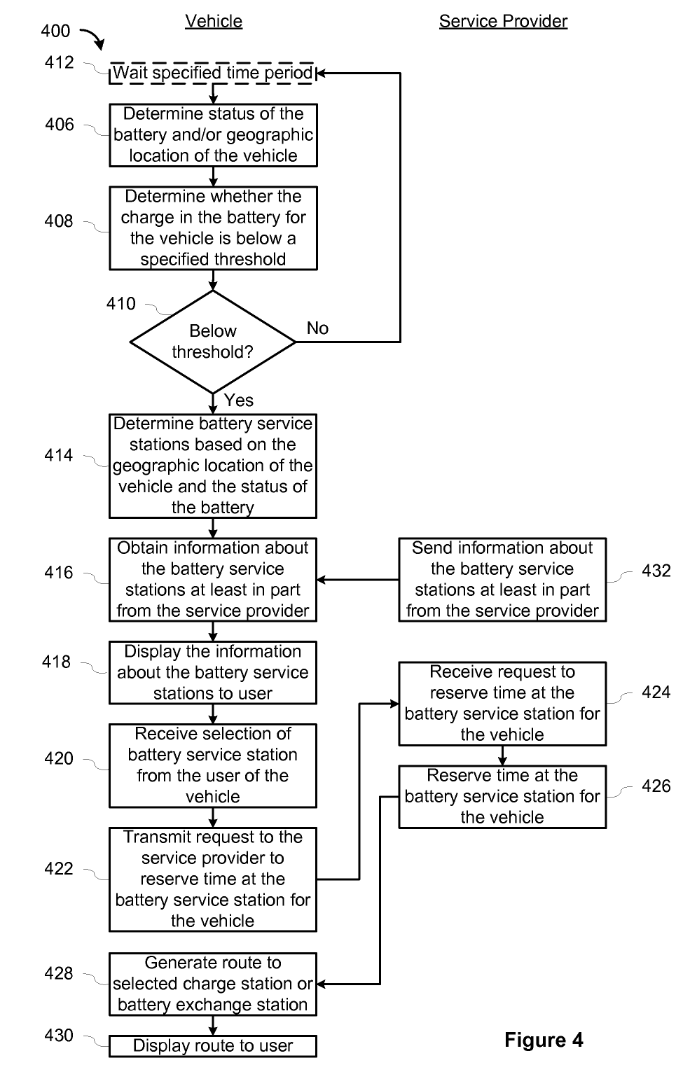

FIG. 4 is a flowchart representing a method 400 for providing information about battery service stations to a user of a vehicle, according to some embodiments. The method 400 begins when the battery status module 1720 of the vehicle 102 determines (406) a status of a battery of the vehicle and the positioning module 1718 of the vehicle 102 determines a geographic location of the vehicle.

The battery status module 1720 of the vehicle 102 then determines from the status of the battery that the battery needs to be recharged. For example, the battery status module 1720 of the vehicle 102 can determine (408) whether a charge level of the battery is below a specified threshold. If the battery does not need to be recharged (410, No), the vehicle 102 waits a specified time period (412) before the method 400 returns to step 406. If the battery needs to be recharged (410, Yes), the positioning module 1718 of the vehicle 102 determines (414) battery service stations based at least in part on the status of the battery and the geographic location of the vehicle 102. In some embodiments, determining battery service stations based at least in part on the status of the battery and the geographic location of the vehicle includes: determining a maximum distance that the vehicle can travel before the battery can no longer power the electric motor of the vehicle, and selecting the battery service stations within the maximum distance from the geographic location of the vehicle.

In some embodiments, the vehicle 102 obtains (416 and 432) information about the battery service stations at least in part from the service provider 112 over the data network 120. In some embodiments, the vehicle 102 periodically receives information about battery service stations from the service provider 112 over the data network 120. In some embodiments, the vehicle 102 also obtains information about the battery service stations from the positioning module 1718 of the vehicle 102. The vehicle 102 displays (418) the information about the battery service stations on a map in the user interface 1705 of the positioning module 1718 of the vehicle 102.

In some embodiments, the vehicle 102 then receives (420) a selection of a battery service station from the user of the vehicle 102 and transmit (422) a request to the service provider 112 to reserve (422) a time slot or time at the battery service station for the vehicle. The service provider 112 receives (424) the request to reserve time at the battery service station for the vehicle 102 and reserves (426) time at the battery service station for the vehicle 102.

The positioning module 1718 of the vehicle 102 may generate (428) a route to the selected battery service station and displays (430) the route to the user on the user interface 1705 of the positioning system 1764 of the vehicle 102. In some embodiments, the vehicle 102 guides the user to the selected battery service station. For example, visual and/or audio route guidance can be provided by the positioning module 1718 of the vehicle 102.

### Monitoring Battery Service Stations

In order to provide information about battery service stations to vehicles in a vehicle-area network, some embodiments monitor the status of battery service stations. The method 500 begins when the battery service station module 1822 of the service provider 112 periodically requests (508) a status of a battery service station over the data network 120. In some embodiments, periodically requesting the status of the battery service station includes periodically transmitting a query to the battery service station over the data network, wherein the query requests the status of the battery service station. The battery service station periodically receives (510) the request for the status of the battery service station and determines (512) the status of the battery service station. For example, the battery exchange module 1922 can determine the status of the battery exchange station 134. Similarly, the battery control module 2020 can determine the status of the charge station 132. The battery service station then sends (514) the status of the battery service station 514 to the service provider 112. In some embodiments, the battery service station may periodically send the status of the battery service station without a request from the service provider 112.

The service provider 112 receives (516) the status of the battery service station over the data network 120 and updates (518) the battery status database 1842 that includes information about battery service stations within the vehicle-area network with the status of the battery service station.

In some embodiments, the service provider 112 distributes (520) at least a portion of the battery service station database 1844 database that includes information about battery service stations to the vehicle 102 in the vehicle-area network over the data network 120. In some embodiments, the at least a portion of the database that includes information about battery service stations is selected based on: a geographic location of the vehicle, a charge level of a battery of the vehicle, and any combination of the aforementioned selection criteria. Furthermore, the service provider 112 may distribute (522) the whole battery service station database 1844 or only new or updated information. The vehicle 102 receives (522) the at least a portion of the battery service station database 1844.

### Providing Energy to Vehicles at a Battery Service Station

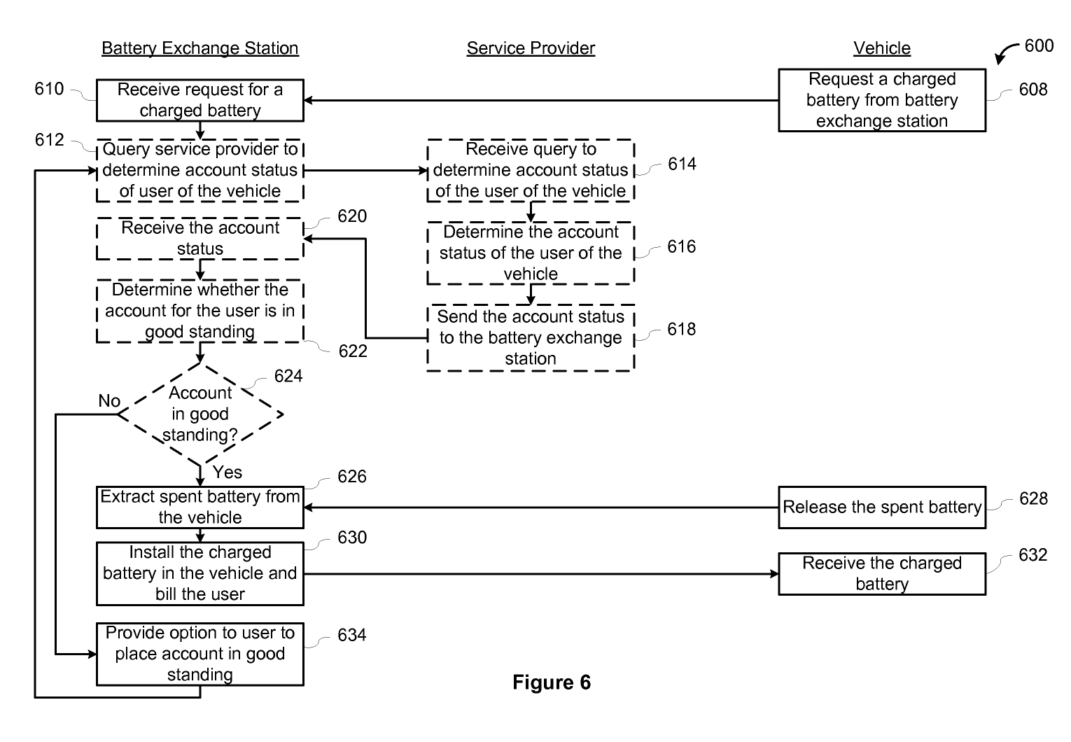

FIG. 6 is a flowchart representing a method 600 for providing a vehicle with energy at a battery exchange station, according to some embodiments. The method 600 begins when the vehicle 102 requests (608) a charged battery from a battery exchange station 134. The battery exchange station 134 receives (610) the request for a charged battery and queries (612) a service provider 602 to determine an account status of the user 110 of the vehicle 102. The service provider 112 receives (614) the query to determine the account status of the user 110 of the vehicle 102 and the account module 1824 of the service provider 112 determines (616) the account status of the user 110 of the vehicle 102. The service provider 112 then sends (618) the account status to the battery exchange station 134.

The battery exchange station 134 receives (620) the status of the account of the user 110 of the vehicle 102 from the service provider 112 over the data network 120. The account module 1924 of the battery exchange station 134 then determines (622) whether the status of the account indicates that the user's account is in good standing. In some embodiments, determining whether the status of the account indicates that the user's account is in good standing includes: determining whether a subscription associated with the account is active, determining whether a funding source associated with the account is valid, determining whether a fee for a subscription associated with the account have been, and any combination of the aforementioned operations.

If the status of the account indicates that the user's account is in good standing (624, Yes), the battery control module 1722 of the vehicle 102 releases (628) the partially spent battery from the vehicle 102 and the battery exchange module 1922 of the battery exchange station 134 extracts (626) the partially spent battery from the vehicle 102. The battery exchange module 1922 of the battery exchange station 134 installs (630 and 632) a charged battery in the vehicle 102 and the account module 1924 of the battery exchange station 134 bills (630) the user's account for the service provided at the battery exchange station 604. In some embodiments, when released from the vehicle 102, the battery 104 is located on an adapter that includes an interfacing face to the battery exchange unit 1960 and an interfacing face to the battery 104. The face interfacing the battery 104 may be unique per battery pack type. The face interfacing the battery exchange unit 1960 devices may be common to all adapters.

If the status of the account indicates that the user's account is not in good standing (624, No), the battery exchange station 134 provides (634) options to the user to place the account in good standing and the method returns to step 612. In some embodiments, the options include: subscribing to a monthly service plan, subscribing to a yearly service plan, subscribing to a mileage-based service plan, subscribing to an energy-consumption-based service plan, subscribing to a pay-per-use plan, and any combination of the aforementioned plans.

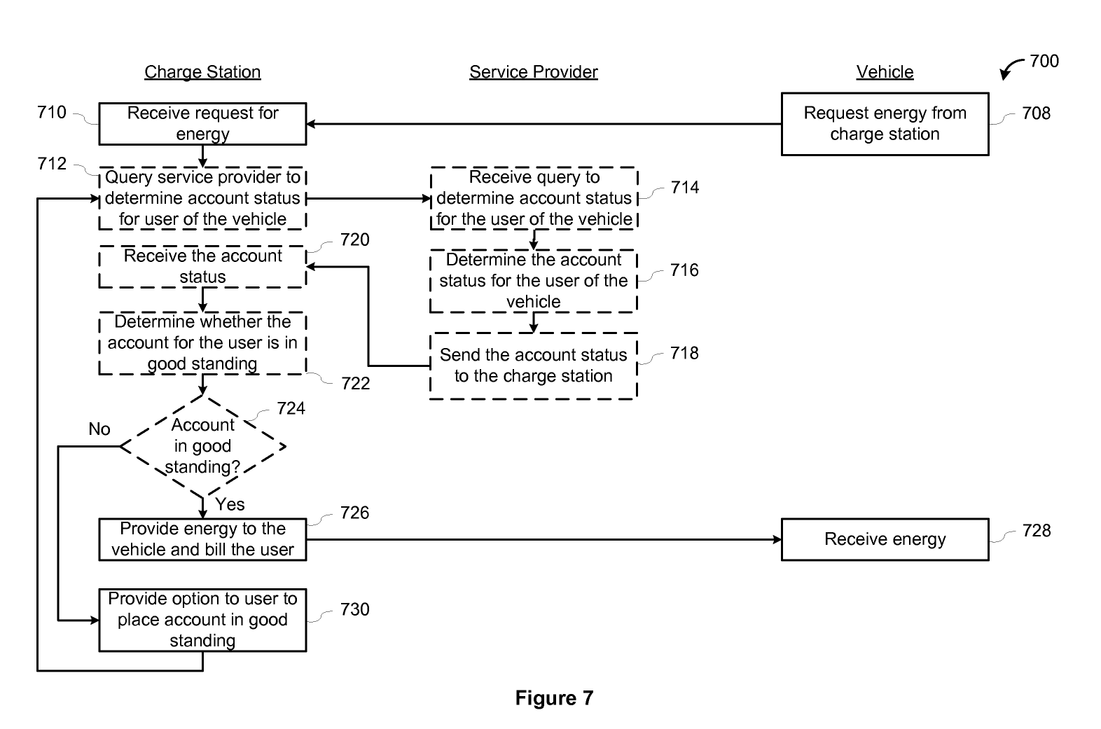

FIG. 7 is a flowchart representing a method 700 for providing a vehicle with energy at a battery service station, according to some embodiments. The method 700 begins when a vehicle 102 requests (708) energy from a charge station 132. The charge station 132 receives (710) the request for energy and the account module 2022 of the charge station 132 queries (712) the service provider 112 to determine an account status of the user of the vehicle. The service provider 112 receives (714) the query to determine the account status of the user 110 of the vehicle 102 and the account module 1824 of the service provider 112 determines (716) the account status of the user of the vehicle. The service provider 112 then sends (718) the account status to the charge station 132.

The charge station 132 receives (720) the status of the user's account of the vehicle 102 from the service provider 112 over the data network 120. The account module 2022 of the charge station 132 then determines (722) whether the status of the account indicates that the user's account is in good standing. In some embodiments, determining whether the status of the account indicates that the user's account is in good standing includes: determining whether a subscription associated with the account is active, determining whether a funding source associated with the account is valid, determining whether a fee for a subscription associated with the account have been, and any combination of the aforementioned operations.

If the status of the account indicates that the user's account is in good standing (724, Yes), the battery control module 2020 of the charge station 132 provides (726 and 728) energy to the vehicle 102 and bills (726) the user's account for the service provided at the charge station 132.

If the status of the account indicates that the user's account is not in good standing (724, No), the charge station 132 provides (730) options to the user to place the account in good standing and the method returns to step 712. In some embodiments, the options include: subscribing to a monthly service plan, subscribing to a yearly service plan, subscribing to a mileage-based service plan, subscribing to an energy-consumption-based service plan, subscribing to a pay-per-use plan, and any combination of the aforementioned plans.

Note that “providing the vehicle with energy” can refer to recharging a battery of a vehicle and/or exchanging a spent battery of the vehicle with a charged battery.

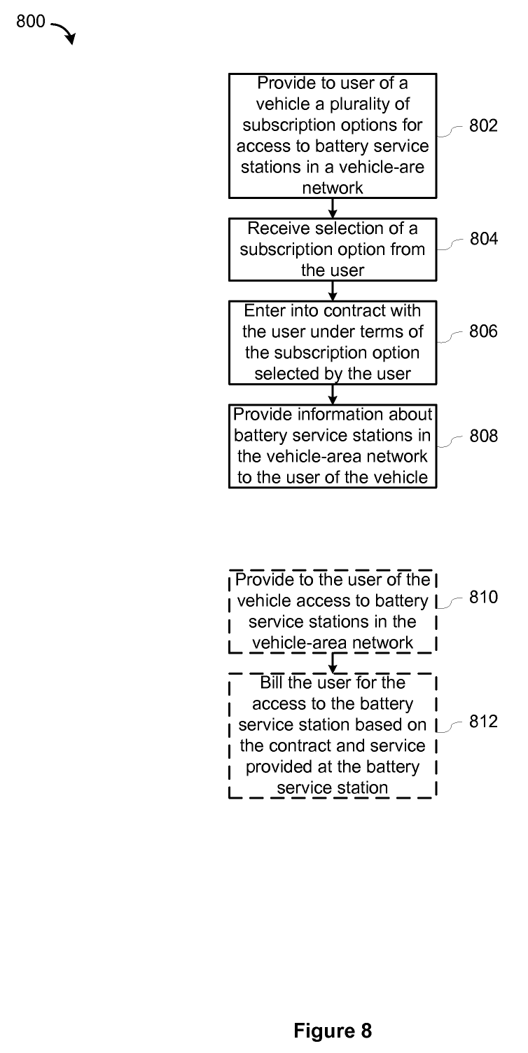

FIG. 8 is a flowchart representing a method 800 for providing access to battery service stations in a vehicle-area network, according to some embodiments. The method 800 begins when a plurality of subscription options for access to battery service stations in a vehicle-area network is provided (802) to the user 110 of the vehicle 102. In some embodiments, the plurality of subscription options include: subscribing to a monthly service plan, subscribing to a yearly service plan, subscribing to a mileage-based service plan, subscribing to an energy-consumption-based service plan, subscribing to a pay-per-use plan, and any combination of the aforementioned plans.

A selection of a subscription option is then received (804) from the user 110. A contract with the user 110 is entered (806) under terms of the subscription option selected by the user 110. Information about battery service stations in the vehicle-area network is provided (808) to the user 110 of the vehicle 102.

The user 110 of the vehicle 102 can then be provided (810) with access to a battery service station. The user is then billed (812) for the access to the battery service station based on the contract and services provided at the battery service station.

### Distributing Energy in a Power Network

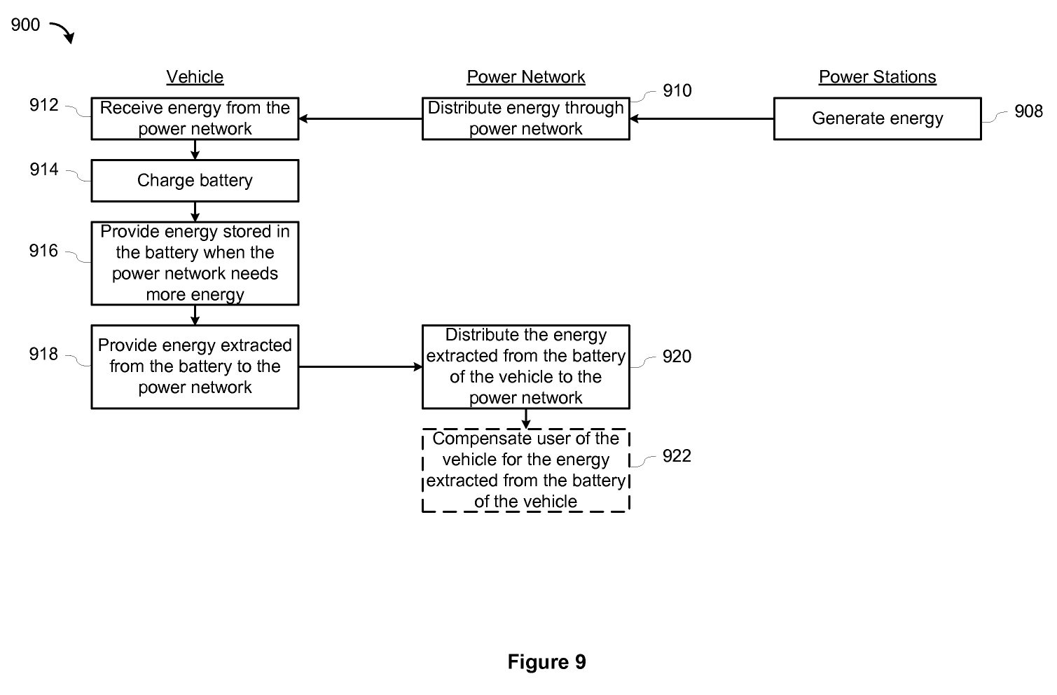

FIG. 9 is a flowchart representing a method 900 for distributing energy in a power network, according to some embodiments. The method 900 begins when the power generators 156 generate (908) energy from one or more power plants.

The energy is then distributed (910) through the power network 140. The vehicle 102 may then receive (912) the energy from the power network 140. The vehicle 102 charges (914) the battery 104 of the vehicle 102 using the energy. In doing so, the vehicle 102 stores energy in the battery 104 of the vehicle 102. In some embodiments, the user 110 of the vehicle 102 is charged for the energy stored in the battery 104 of the vehicle 102.

The vehicle 102 provides (916) energy stored in the battery 104 of the vehicle 102 when energy production from the one or more power plants is below the demand placed on the power network and provides (918) the energy extracted from the battery to the power network 140. The energy extracted from the battery 104 of the vehicle 102 (or in some embodiments, batteries of a plurality of vehicles) is then distributed (920) to the power network 140. In some embodiments, the user 110 of the vehicle 102 is compensated (922) for the energy extracted from the battery 104 of the vehicle 102.

Note that the process described in FIG. 9 can also be applied to batteries that are located at battery exchange stations and/or batteries not associated with vehicles.

### Relationships Between Users, Service Providers, and Financial Institutions

FIGS. 10-16 describe a number of relationships between users, service providers, and financial institutions, according to some embodiments. In some embodiments, the financial institution can take on the role and/or the services provided by the service provider as described above, or vice versa. In some embodiments, a financial institution owns the battery service stations and/or the vehicle-area network. In some embodiments, a service provider owns the battery service stations and/or the vehicle-area network.

FIG. 10 is a flowchart representing a method 1000 for establishing a relationship between a user of a vehicle and a service provider, according to some embodiments. The method 1000 begins when the user 110 enters (1006 and 1008) into a contract with the service provider 112 to obtain the vehicle 102, the battery 104, and/or access to vehicle-area network services. The service provider 112 provides (1010) and the user 110 receives (1012) the vehicle 102, the battery 104, and/or access to the vehicle-area network services. Thus, in the relationship described in FIG. 10, the service provider 112 owns the vehicle 102, the battery 104, and the vehicle-area network services.

The user 110 can then periodically request (1014), and the service provider 112 can periodically provide (1016), the vehicle-area network services.

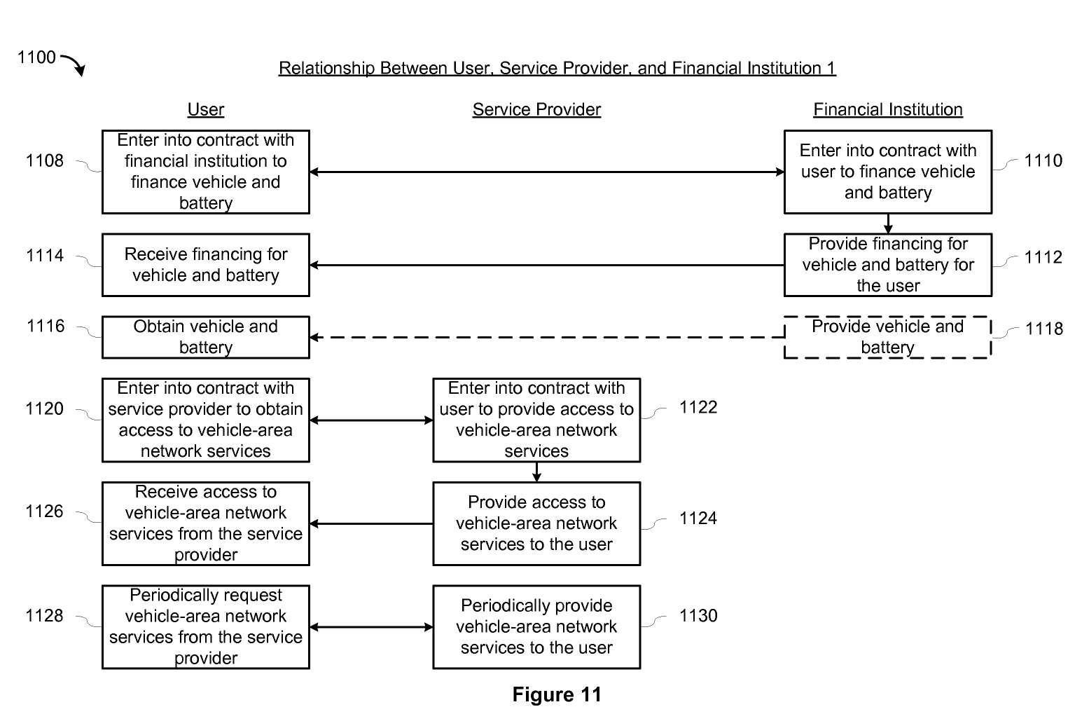

FIG. 11 is a flowchart representing a method 1100 for establishing a relationship between a user of a vehicle, a service provider, and a financial institution, according to some embodiments. The method 1100 begins when the user 110 enters (1108 and 1110) into a contract with the financial institution 114 to finance the vehicle 102 and the battery 104. For example, the financing can include a loan or a lease. The financial institution 114 provides (1112) and the user 110 receives (1114) financing for the vehicle 102 and the battery 104.

In some embodiments, the financial institution 114 provides (1118) and the user 110 obtains (1116) the vehicle 102 and the battery 104. Alternatively, the user 110 can obtain the vehicle 102 and the battery 104 from a third party (e.g., a car dealer).

The user 110 enters into a contract with the service provider 112 to obtain (1120 and 1122) access to vehicle-area network services. The service provider 112 then provides (1124) and the user 110 receives (1126) access to the vehicle-area network services.

Thus, in the relationship described in FIG. 11, the financial institution 114 owns the vehicle 102 and the battery 104, and the service provider 112 owns the vehicle-area network services.

The user 110 can then periodically request (1128) and the service provider 112 can periodically provide (1130) access to the vehicle-area network services.

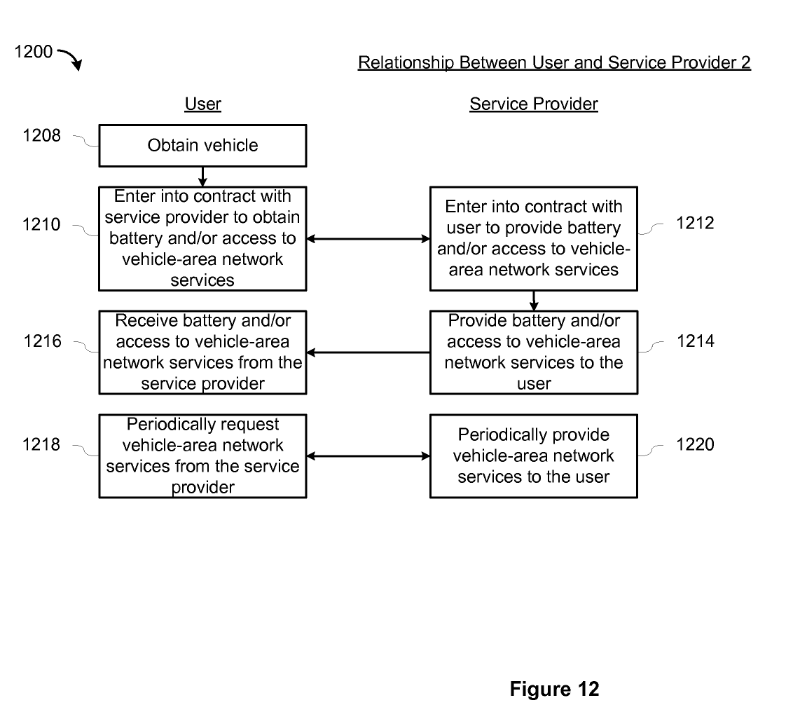

FIG. 12 is a flowchart representing a method 1200 for establishing a relationship between a user of a vehicle and a service provider, according to some embodiments. The method 1200 begins when the user 110 obtains (1208) the vehicle 102. For example, the user 110 can obtain the vehicle 102 from a third party (e.g., a car dealer). The user 110 enters (1210 and 1212) into a contract with the service provider 112 to obtain the battery 104 and/or access to vehicle-area network services. The service provider 112 provides (1214) and the user 110 receives (1216) the battery 104 and/or access to the vehicle-area network services.

Thus, in the relationship described in FIG. 12, the user 110 owns the vehicle 102 and the service provider owns the battery 104 and the vehicle-area network services.

The user 110 can then periodically request (1218) and the service provider 112 can periodically provide (1220) the vehicle-area network services.

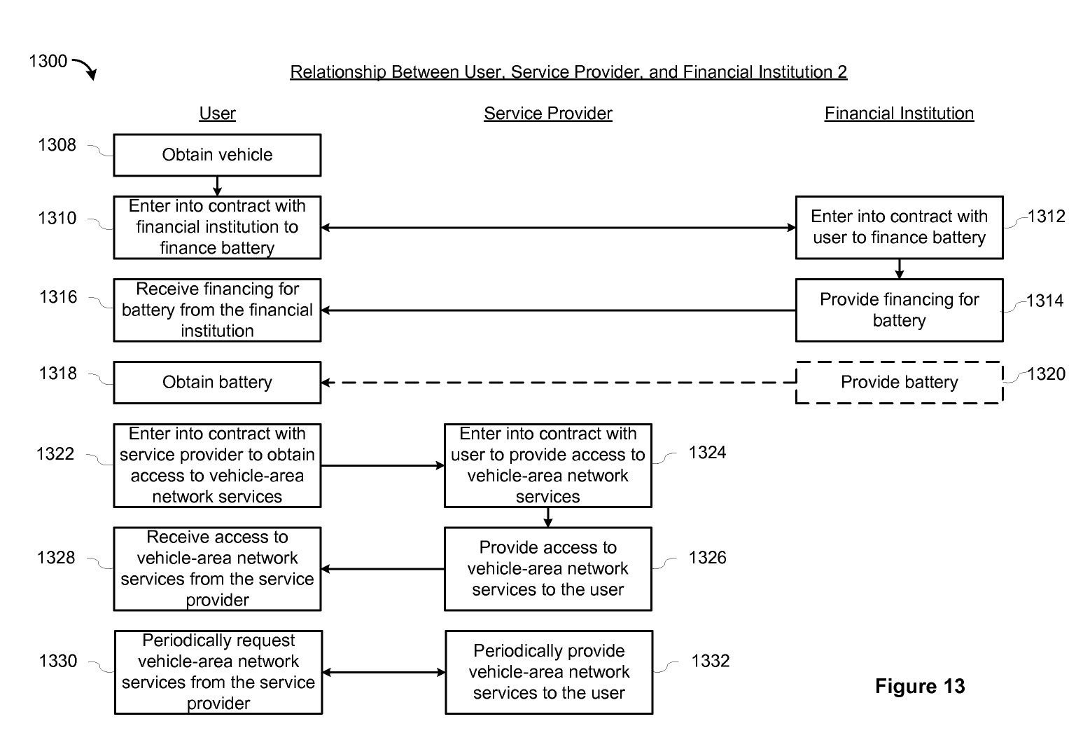

FIG. 13 is a flowchart representing a method 1300 for establishing a relationship between a user of a vehicle, a service provider, and a financial institution, according to some embodiments. The method 1300 begins when the user 110 obtains (1308) a vehicle. For example, the user 110 can obtain a vehicle from a third party (e.g., a car dealer). The user 110 enters (1310 and 1312) into a contract with the financial institution 114 to finance the battery 104. For example, the financing can include a loan or a lease. The financial institution 114 provides (1314) and the user 110 receives (1316) financing for the battery.

In some embodiments, the financial institution 114 provides (1320) and the user 110 obtains (1320) the battery 104. Alternatively, the user 110 can obtain the battery from a third party.

The user 110 enters (1322 and 1324) into a contract with the service provider 112 to obtain access to vehicle-area network services. The service provider 112 provides (1424) and the user 110 receives (1326) access to the vehicle-area network services.

Thus, in the relationship described in FIG. 13, the user 110 owns the vehicle 102, the financial institution 114 owns the battery 104, and the service provider 112 owns the vehicle-area network services.

The user 1302 can then periodically request and the service provider 1304 can periodically provide access to the vehicle-area network services (1330 and 1332).

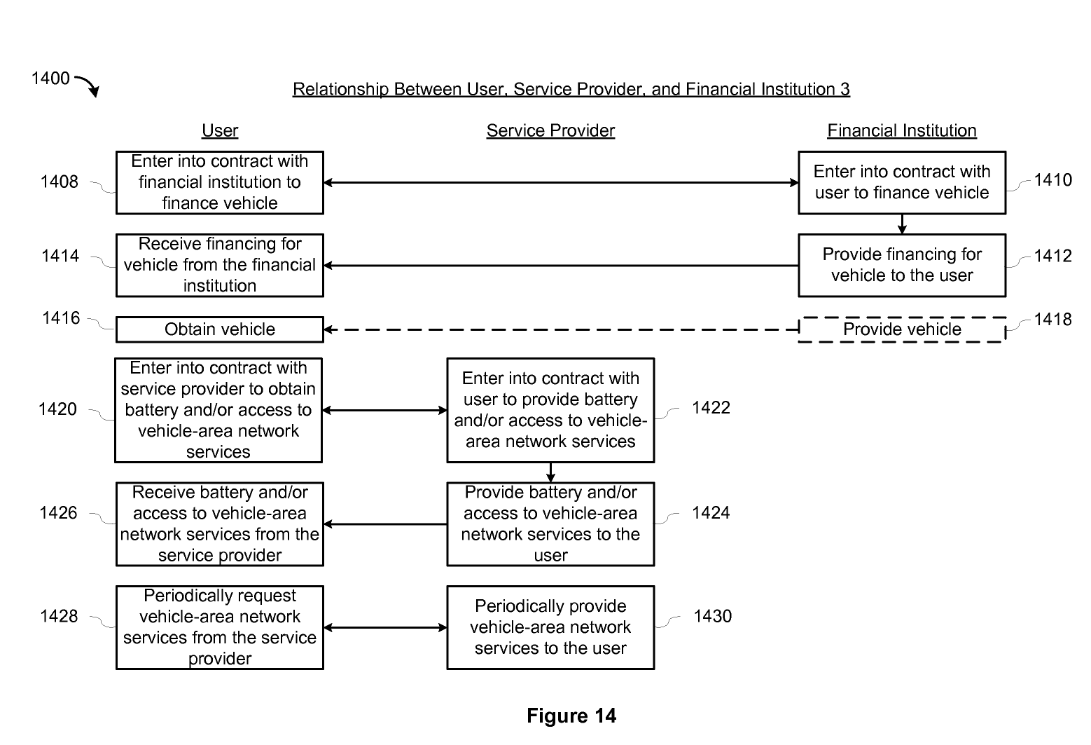

FIG. 14 is a flowchart representing a method 1400 for establishing a relationship between a user of a vehicle, a service provider, and a financial institution, according to some embodiments. The method 1400 begins when the user 110 enters (1408 and 1410) into a contract with the financial institution 114 to finance the vehicle 102. For example, the financing can include a loan or a lease. The financial institution 114 provides (1412) and the user 110 receives (1414) financing for the vehicle 102.

In some embodiments, the financial institution 114 provides (1418) and the user 110 obtains (1416) the vehicle. Alternatively, the user 110 can obtain the vehicle 102 from a third party.

The user 110 enters (1420 and 1422) into a contract with the service provider 112 to obtain a battery and access to vehicle-area network services. The service provider 112 provides (1424) and the user 110 receives (1426) the battery 104 and access to the vehicle-area network services.

Thus, in the relationship described in FIG. 14, the financial institution 114 owns the vehicle 102, the service provider 112 owns the battery 104 and the vehicle-area network services.

The user 110 can then periodically request (1428) and the service provider 112 can periodically provide (1430) access to the vehicle-area network services.

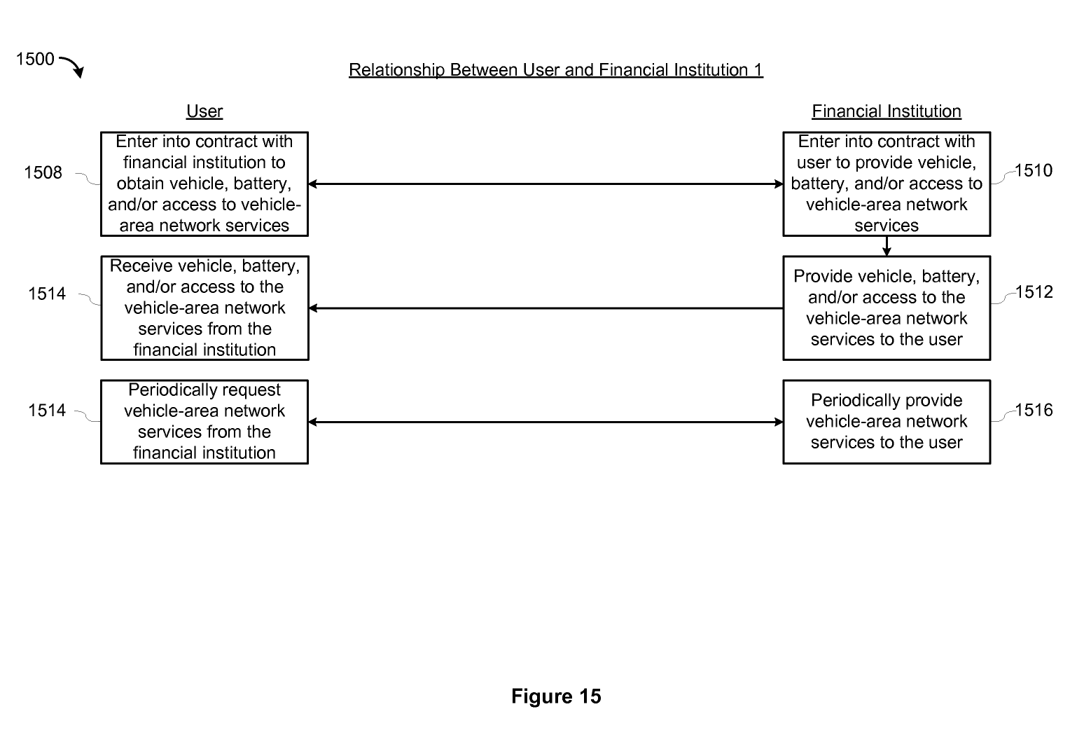

FIG. 15 is a flowchart representing a method 1500 for establishing a relationship between a user of a vehicle and a financial institution, according to some embodiments. The method 1500 begins when the user 110 enters (1508 and 1510) into a contract with the financial institution 114 to obtain the vehicle 102, the battery 104, and/or access to vehicle-area network services. The financial institution 114 provides (1512) and the user 110 receives (1514) the vehicle 102, the battery 104, and/or access to the vehicle-area network services.

Thus, in the relationship described in FIG. 15, the financial institution 114 owns the vehicle 102, the battery 104, and the vehicle-area network services.

The user 110 can then periodically request (1514) and the financial institution 114 can periodically provide (1516) the vehicle-area network services.

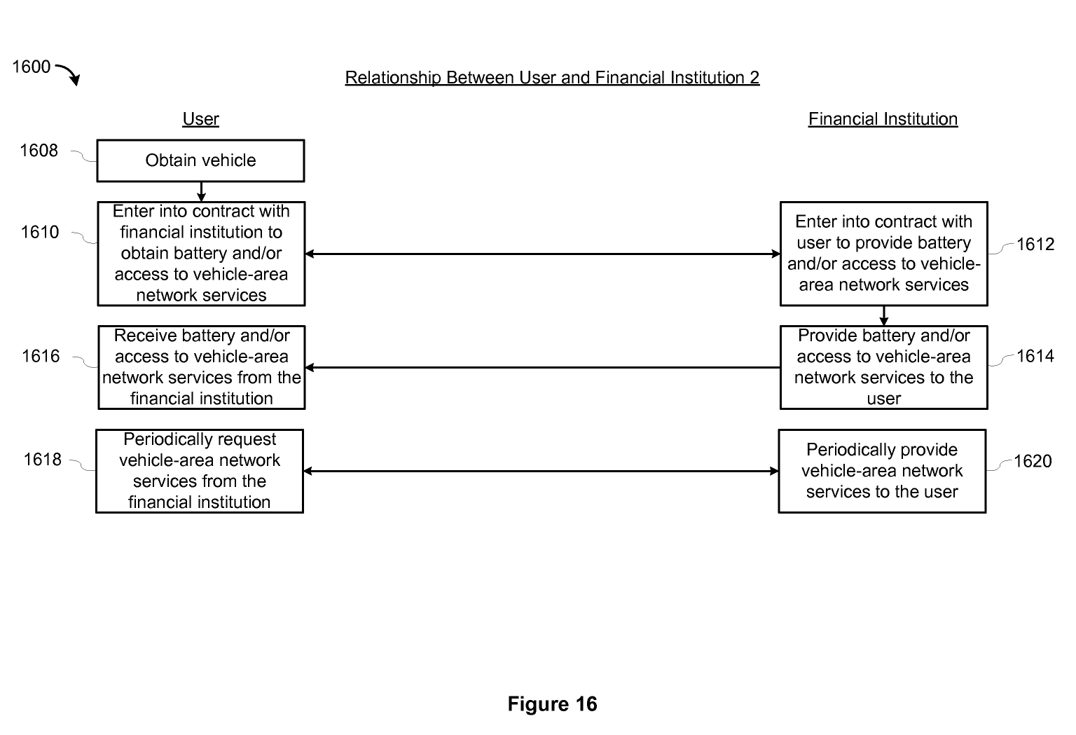

FIG. 16 is a flowchart representing a method 1600 for establishing a relationship between a user of a vehicle and a financial institution, according to some embodiments. The method 1600 begins when the user 110 obtains (1608) the vehicle 102. For example, the user 110 can obtain the vehicle 102 from a third party (e.g., a car dealer). The user 110 enters (1610 and 1612) into a contract with the financial institution 114 to obtain the battery 104 and/or access to vehicle-area network services. The financial institution 114 provides (1614) and the user 110 receives (1616) the battery 104 and/or access to the vehicle-area network services.

Thus, in the relationship described in FIG. 16, the user 110 owns the vehicle 102 and the financial institution 114 owns the battery 104 and the vehicle-area network services.

The user 110 can then periodically request (1618) and the financial institution 114 can periodically provide (1620) the vehicle-area network services.

Each of the methods described herein may be governed by instructions that are stored in a computer readable storage medium and that are executed by one or more processors of one or more computer system. Each of the operations shown in FIGS. 2-16 may correspond to instructions stored in a computer memory or computer readable storage medium.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for providing information about battery service stations to an electric vehicle that includes an electric motor that drives one or more wheels of the vehicle and is powered by a battery, the method comprising:
at a vehicle,
determining a status of a battery of the vehicle;
determining a geographic location of the vehicle;
identifying at least one battery service station that the vehicle can reach based on the charge status of the battery of the vehicle and the geographic location of the vehicle; and
notifying the user of the at least one battery service station to a user of the vehicle.

2. The method of claim 1, further comprising at the vehicle, displaying the geographic location of the vehicle relative to at least one battery service station on a map in a user interface of a positioning system of the vehicle.

3. The method of claim 1, further comprising at the vehicle, marking the battery service stations that the vehicle can reach on the map.

4. The method of claim 1, wherein the at least one battery service station is a charge stations that recharges the battery of the vehicle or a battery exchange station that replaces an at least partially spent battery of the vehicle with a charged battery.

5. The method of claim 1,
wherein the battery is not owned by the user, and
wherein the user of the vehicle is a user that has legal title to the vehicle, or a user that has legal possession of the vehicle.

6. The method of claim 1, further comprising:
receiving a selection of a battery service station from a user of the vehicle; and
making a reservation at the battery service station for the vehicle.

7. The method of claim 1, wherein determining the status of the battery of the vehicle includes one selected from the group consisting of:
determining a charge level of the battery;
determining an age of the battery;
determining the number of charge/discharge cycles of the battery; and
any combination of the aforementioned operations.

8. The method of claim 1, wherein identifying the battery service stations that the vehicle can reach based on the status of the battery of the vehicle includes:
determining a maximum distance that the vehicle can travel before the battery can no longer power the electric motor of the vehicle; and
determining the battery service stations that are within the maximum distance from the geographic location of the vehicle.

9. The method of claim 8, wherein the maximum distance includes a specified safety factor.

10. The method of claim 1, including:
determining a maximum distance that the vehicle can travel before the battery can no longer power the electric motor of the vehicle; and
marking in a user interface of a positioning system of the vehicle an area of a map that is within the maximum distance of the geographic location of the vehicle.

11. The method of claim 1, including periodically transmitting the status of the battery of the vehicle to a service provider over a data network.

12. The method of claim 1, including periodically transmitting the geographic location of the vehicle to a service provider over a data network.

13. The method of claim 1, including periodically receiving a status of the battery service stations from a service provider over a data network.

14. The method of claim 13, wherein the status of a respective battery service station is selected from the group consisting of:
a number of charge stations of the respective battery service station that are occupied;
a number of charge stations of the respective battery service station that are free;
a number of battery exchange bays of the respective battery service station that are occupied;
a number of battery exchange bays of the respective battery service station that are free;
a location of the battery service station; and
and any combination of the aforementioned statuses.

15. A vehicle that includes an electric motor that drives one or more wheels of the vehicle and is powered by a battery, comprising:
one or more processors;
a memory; and
one or more programs stored in the memory, the one or more programs comprising instructions to:
determine a status of a battery of the vehicle;
determine a geographic location of the vehicle;
identify at least one battery service station that the vehicle can reach based on the charge status of the battery of the vehicle and the geographic location of the vehicle; and
notify the user of the at least one battery service station to a user of the vehicle.

16. The vehicle of claim 15, further comprising instructions to display the geographic location of the vehicle relative to at least one battery service station on a map in a user interface of a positioning system of the vehicle.

17. The vehicle of claim 15, further comprising instructions to mark the battery service stations that the vehicle can reach on the map.

18. The vehicle of claim 15, wherein the at least one battery service station is a charge station that recharge the battery of the vehicle, or a battery exchange station that replaces an at least partially spent battery of the vehicle with a charged battery.

19. The vehicle of claim 15,
wherein the battery is not owned by user, and
wherein the user of the vehicle a user that has legal title to the vehicle, or a user that has legal possession of the vehicle.

20. The vehicle of claim 15, further comprising instructions to:
receive a selection of a battery service station from a user of the vehicle; and
making a reservation at the battery service station for the vehicle.

21. The vehicle of claim 15, wherein the instruction to determine the status of the battery of the vehicle includes one selected from the group consisting of:
instructions to determine a charge level of the battery;
instructions to determine an age of the battery;
instructions to determine the number of charge/discharge cycles of the battery; and
any combination of the aforementioned instructions.

22. The vehicle of claim 15, wherein the instructions to identify the battery service stations that the vehicle can reach based on the status of the battery of the vehicle includes instruction to:
determine a maximum distance that the vehicle can travel before the battery can no longer power the electric motor of the vehicle; and
determine the battery service stations that are within the maximum distance from the geographic location of the vehicle.

23. The vehicle of claim 22, wherein the maximum distance includes a specified safety factor.

24. The vehicle of claim 15, further comprising instructions to:
determine a maximum distance that the vehicle can travel before the battery can no longer power the electric motor of the vehicle; and
mark in a user interface of a positioning system of the vehicle an area of a map that is within the maximum distance of the geographic location of the vehicle.

25. The vehicle of claim 15, including instruction to periodically transmit the status of the battery of the vehicle to a service provider over a data network.

26. The vehicle of claim 15, including instruction to periodically transmit the geographic location of the vehicle to a service provider over a data network.

27. The vehicle of claim 15, including instructions to periodically receive a status of the battery service stations from a service provider over a data network.

28. The vehicle of claim 27, wherein the status of a respective battery service station is selected from the group consisting of:
a number of charge stations of the respective battery service station that are occupied;
a number of charge stations of the respective battery service station that are free;
a number of battery exchange bays of the respective battery service station that are occupied;
a number of battery exchange bays of the respective battery service station that are free;
a location of the battery service station; and
and any combination of the aforementioned statuses.

29. A computer readable storage medium storing one or more programs configured for execution by a computer, the one or more programs comprising instructions to:
determine a status of a battery of the vehicle, wherein the vehicle includes an electric motor that drives one or more wheels of the vehicle, wherein the electric motor receives energy from the battery;
determine a geographic location of the vehicle;
identify at least one battery service station that the vehicle can reach based on the charge status of the battery of the vehicle and the geographic location of the vehicle; and
notify the user of the at least one battery service station to a user of the vehicle.

30. The computer readable storage medium of claim 29, further comprising instructions to display the geographic location of the vehicle relative to at least one battery service station on a map in a user interface of a positioning system of the vehicle.

31. The computer readable storage medium of claim 29, further comprising instructions to mark the battery service stations that the vehicle can reach on the map.

32. The computer readable storage medium of claim 29, wherein the at least one battery service station is a charge station that recharge the battery of the vehicle or a battery exchange station that replaces an at least partially spent battery of the vehicle with a charged battery.

33. The computer readable storage medium of claim 29,
wherein the battery is not owned by the user, and
wherein the user of the vehicle is a user that has legal title to the vehicle, or a user that has legal possession of the vehicle.

34. The computer readable storage medium of claim 29, further comprising instructions to:
receive a selection of a battery service station from a user of the vehicle; and
making a reservation at the battery service station for the vehicle.

35. The computer readable storage medium of claim 29, wherein the instructions to determine the status of the battery of the vehicle includes one selected from the group consisting of:
instructions to determine a charge level of the battery;
instructions to determine an age of the battery;
instructions to determine the number of charge/discharge cycles of the battery; and
any combination of the aforementioned instructions.

36. The computer readable storage medium of claim 29, wherein the instructions to identify the battery service stations that the vehicle can reach based on the status of the battery of the vehicle includes instructions to:
determine a maximum distance that the vehicle can travel before the battery can no longer power the electric motor of the vehicle; and
determine the battery service stations that are within the maximum distance from the geographic location of the vehicle.

37. The computer readable storage medium of claim 36, wherein the maximum distance includes a specified safety factor.

38. The computer readable storage medium of claim 29, including instructions to:
determine a maximum distance that the vehicle can travel before the battery can no longer power the electric motor of the vehicle; and
mark in a user interface of a positioning system of the vehicle an area of a map that is within the maximum distance of the geographic location of the vehicle.

39. The computer readable storage medium of claim 29, including instructions to periodically transmit the status of the battery of the vehicle to a service provider over a data network.

40. The computer readable storage medium of claim 29, including instructions to periodically transmit the geographic location of the vehicle to a service provider over a data network.

41. The computer readable storage medium of claim 29, including instructions to periodically receive a status of the battery service stations from a service provider over a data network.

42. The computer readable storage medium of claim 41, wherein the status of a respective battery service station is selected from the group consisting of:
a number of charge stations of the respective battery service station that are occupied;
a number of charge stations of the respective battery service station that are free;
a number of battery exchange bays of the respective battery service station that are occupied;
a number of battery exchange bays of the respective battery service station that are free;
a location of the battery service station; and
and any combination of the aforementioned statuses.
